(19) United States
(12) Patent Application Publication
(10) Pub. No.: US 2025/0096853 A1
(43) Pub. Date: Mar. 20, 2025

(54) METHOD AND APPARATUS FOR CONFIGURING RECONFIGURABLE INTELLIGENT SURFACES FOR WIRELESS COMMUNICATION

(71) Applicant: HUAWEI TECHNOLOGIES CO., LTD., SHENZHEN (CN)

(72) Inventors: Remziye Irem BOR YALINIZ, Kanata (CA); Nimal Gamini SENARATH, Kanata (CA)

(73) Assignee: HUAWEI TECHNOLOGIES CO., LTD., SHENZHEN (CN)

(21) Appl. No.: 18/968,666

(22) Filed: Dec. 4, 2024

Related U.S. Application Data
(63) Continuation of application No. PCT/CN2022/097044, filed on Jun. 6, 2022.

(51) Int. Cl. H04B 7/04; H04W 72/30

(52) U.S. Cl. CPC H04B 7/04013; H04W 72/30

(57) ABSTRACT

There is provided methods and apparatuses for configuring reconfigurable intelligent surfaces (RISs) to support network service. According to embodiments, there are provided centralized, distributed and hybrid methods for determining a set of base stations that can be responsible for control and communication (C&C) of RIS. In particular, there are provided RIS C&C architectures, RIS-specific messaging protocols in various scenarios, and a grid-based method for facilitation of RIS related analysis.

### CROSS-REFERENCE TO RELATED APPLICATIONS

This application is a continuation of International Patent Application No. PCT/CN2022/097044, filed Jun. 6, 2022, entitled “METHOD AND APPARATUS FOR CONFIGURING RECONFIGURABLE INTELLIGENT SURFACES FOR WIRELESS COMMUNICATION” the contents of which are incorporated herein by reference in their entirety.

### TECHNICAL FIELD

The present disclosure pertains to the field of wireless communication and in particular to a method and apparatus for configuring reconfigurable intelligent surfaces (RISs) to support network service.

### BACKGROUND

Reconfigurable intelligent surface (RIS) or intelligent reflective surface (IRS) is a programmable planar surface that can be used to control the propagation of wireless signals or electromagnetic waves by changing properties of the surface. RIS includes a large number of reflective elements. Each reflective element performs a controllable phase shift to the incident signal. RIS can be deployed at various places or locations such as exterior of buildings (e.g. windows, wall), walls on the street or indoor spaces.

There are many uses for RIS especially in wireless networks. For example, RIS can be used to create virtual line of sight (LoS) channels between a base station and users thereby overcoming the none-line-of-sight issue. RIS can be also used to mitigate signal interference by controlling the phase shift of the reflective elements or creating destructive interference for security purposes.

Existing RIS technologies and studies focus on utilizing RIS, for example developing applications that can benefit from RIS or optimizing RIS run time operations. In particular, the vast majority of RIS studies are related to solutions to arrange a phase shift array of the RIS with objectives including reducing signal-to-noise-ratio (SNR), protection from unauthorized or adversarial users or increasing aggregation rate. Existing RIS technologies and studies use a variety of algorithms for optimization of the phase shifts, including alternate optimization and reinforcement learning.

On the other hand, existing RIS technologies and studies do not propose solutions for where these algorithms can be implemented or how computational load of RIS control can be managed. Also, existing RIS technologies and studies neither provide any messaging protocols or architectures that provide effective RIS control, nor analyze wireless networks in terms of their capability to manage RIS. Instead, it is assumed that the network has sufficient capacity.

However, in consideration of the current state of wireless network, such assumptions are not accurate and should not be made. While current wireless networks can support and manage RIS, enhancements are needed to effectively manage wireless networks and support RIS elements. Therefore there is a need for a method and apparatus for configuring reconfigurable intelligent surfaces (RISs) to support network service, that is not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method and apparatus for configuring one or more reconfigurable intelligent surfaces (RISs) to support network service. In accordance with embodiments of the present disclosure, there is provided a method for configuring one or more reconfigurable intelligent surface (RIS) deployments, each RIS deployment including one or more RISs to support network services. The method includes sending a request for RIS information. The method further includes receiving the RIS information, the received RIS information including information indicative of one or more of: a capability of one or more base stations for provision of control and communication (C&C) of the one or more RIS deployments, one or more configurable RISs and one or more characteristics of each base station. The method additionally includes determining a RIS C&C set based on one or more of: (a) one or more characteristics of each base station, and (b) the one or more characteristics of one or more of the one or more RIS deployments and an associated RIS controller included in the RIS information, the RIS C&C set including one or more base stations responsible for C&C of the one or more RIS deployments.

A technical benefit of at least some embodiments of the present disclosure may be the provision of a method and apparatus for defining control and communication set determination.

In some embodiments, the one or more characteristics of each base station including one or more of: proximity to the one or more RISs of the RIS deployment, channel quality of the base station, RIS usage, services to be provided using the one or more RISs of the RIS deployment, computational power of the base station and expected network traffic in an area covered by the base station.

In some embodiments, when an RIS controller is not connected to a base station through a communication link, the method further includes establishing, by the associated RIS controller, communication with the particular base station. In some embodiments, establishing communication includes sending a pilot signal by the RIS controller and upon detection of the pilot signal by the base station, establishing a communication link with the particular RIS controller. In some embodiments, establishing communication includes listening and searching, by the RIS controller, radio signals broadcast by a plurality of base stations and sending a connection request to one or more selected base stations. In response particular base stations will establish communication with the RIS controller. In some embodiments the radio signals include the base station information indicating at least the C&C capabilities of the base station. In some embodiments the base station information includes one or more RIS-IDs indicating the one or more RIS deployments to be used by the base station which sent the broadcast signal. In some embodiments selection of the base stations for connection establishment is done based on the received base station information.

In some embodiments, the method further includes performing, by the one or more base stations, a channel sensing process, the channel sensing process including one or more of sensing communication links between the one or more base stations and the set of RISs requiring C&C, and sensing cascade channels between the one or more base stations, the set of RISs requiring C&C and a terminal device.

In some embodiments, the RIS information includes information indicative of characteristics of each RIS of the RIS deployment, the RIS characteristics including a number of reflective elements associated with each RIS.

In some embodiments, the RIS information further includes one or more of: location of each RIS, RIS controller information, expected network traffic RIS can serve, expected geographical area a particular RIS can serve indicated by one or more grid locations or gird IDs that can be served and associated angles to be used for each of the one or more grid locations or grid IDs, expected available computational power of each base stations, information indicative of whether channel sensing is required, information for cascaded channels of each RIS, frequency of C&C update, and information indicative of reflective elements associated with each RIS.

In some embodiments, the RIS C&C set is determined further based on a traffic capacity of grids, each grid indicative of a portion of a geographical area expected to be served with at least one of the base stations. In some embodiments, the capacity of the grids is determined based on one or more of configurations of the one or more RIS deployments and a number of reflective elements of each RIS required for capacity of each grid. In some embodiments, the capacity of the grid is indicative of one or more of a peak data rate, a spectral efficiency. In some embodiments, the capacity of a grid can define the traffic handling capacity. In some embodiments, the capacity of a grid can define the expected or current traffic demand of the geographical area included within the grid. In some embodiments, one or more grids associated with each of reflective elements of the each RIS are determined based on one or more of a surrounding environment, a visual line-of-sight, a wave line-of-sight and angles associated with the reflective elements.

In some embodiments, the one or more base stations cooperate with one or more of other of the one or more base stations, one or more central network entities and one or more network managers for determination of the RIS C&C set.

In some embodiments, the RIS C&C set is determined by a central network entity or one or more of the base stations preconfigured by the central network entity.

In some embodiments, the one or more base stations join or leave the RIS C&C set based on information exchanged between the one or more base stations to determine capability of each base station to provide C&C of the one or more RIS deployments, the exchanged information including one or more of: current traffic, historical load analysis of traffic and computation, channel between the one or more base stations and the one or more RISs associated with the RIS deployment, available bandwidths for RIS control, available processing power for RIS configuration, available crowd sourcing methods and available learning methods.

In some embodiments, the RIS C&C set is collaboratively determined by the one or more base stations. Determining the RIS C&C set includes transmitting, by a base station of the one or more base stations to other of the one or more base stations, C&C queries for RISs of the RIS deployment that can be served by the other of the one or more base stations and receiving, by the base station of the one or more base stations, C&C query responses including the RISs of the RIS deployment that can be served by the other one or more base stations. Determining the RIS C&C further includes evaluating, by the base station of the one or more base stations, the received C&C query response until one or more convergence criteria are met.

In accordance with embodiments of the present disclosure, there is provided an apparatus for configuring one or more reconfigurable intelligent surface (RIS) deployments, each RIS deployment including one or more RISs to support network services. The apparatus includes a processor and a a memory storing machine executable instructions. The instructions when executed by the processor configure the apparatus to send a request for RIS information. The instructions when executed by the processor further configure the apparatus to receive the RIS information, the received RIS information including information indicative of one or more of: a capability of one or more base stations for provision of control and communication (C&C) of the one or more RIS deployments, one or more configurable RISs and one or more characteristics of each base station. The instructions when executed by the processor further configure the apparatus to determine a RIS C&C set based on one or more of: (a) one or more characteristics of each base station, and (b) the one or more characteristics at least in part determined from the RIS information, the RIS C&C set including one or more base stations responsible for C&C of the one or more RIS deployments.

In accordance with embodiments of the present disclosure, there is provided a system for configuring one or more reconfigurable intelligent surface (RIS) deployments, each RIS deployment including one or more RISs to support network services. The system includes a RIS controller, one or more base stations and a central manager (CM). The CM is configured to send a request for RIS information to each of the one or more base stations. Each base station is configured to receive the RIS information from the RIS controller associated with the one or more RIS deployments. Each base station is further configured to send second RIS information to the CM, the second RIS information including information indicative of a capability of the base station for provision of control and communication (C&C) of the one or more RIS deployments, one or more configurable RISs and one or more characteristics of the base station. The CM is further configured to determine a RIS C&C set based on one or more characteristics of the one or more base stations, the one or more characteristics at least in part determined from the second RIS information, the RIS C&C set including one or more base stations responsible for C&C of the RIS deployments.

In accordance with embodiments of the present disclosure, there is provided a system for configuring one or more reconfigurable intelligent surface (RIS) deployments, each RIS deployment including one or more RISs to support network services. The system including a RIS controller and a base station. The base station is configured to send a request for RIS information to the RIS controller, the RIS information associated with one or more of the one or more RIS deployments. The RIS controller is configured to send the RIS information to the base station. The base station is further configured to determine a RIS C&C based on one or more characteristics at least in part determined from the RIS information, the RIS C&C including the one or more RIS deployments selected by the base station.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 illustrates a reconfigurable intelligent surface (RIS) system deployed on a façade of a building.

FIG. 2 illustrates centralized selection of RIS control and communication (C&C) set, in accordance with embodiments of the present disclosure.

FIG. 3 illustrates control of distributed RIS C&C set selection, in accordance with embodiments of the present disclosure.

FIG. 4 illustrates a method of centralized RIS C&C set derivation with NSMF and NSSMF, in accordance with embodiments of the present disclosure

FIG. 5 illustrates a method of RIS C&C by a central manager, in accordance with embodiments of the present disclosure.

FIG. 6 defines the content and details relating to the RIS information request, in accordance with embodiments.

FIG. 7 defines the content and details of the RIS information response, in accordance with embodiments.

FIG. 8 defines the content and details of the RIS C&C message, in accordance with embodiments.

FIG. 9 illustrates an RIS discovery method, in accordance with embodiments of the present disclosure.

FIG. 10 defines the content and details of the service query message, in accordance with embodiments.

FIG. 11 defines the content and details of the service query response message, in accordance with embodiments.

FIG. 12 illustrates a RIS discovery method when RIS is unknown to the base station, in accordance with embodiments of the present disclosure.

FIG. 13 illustrates an infrastructure-based RIS sharing method, in accordance with embodiments of the present disclosure.

FIG. 14 illustrates an infrastructure-based RIS sharing method, in accordance with embodiments of the present disclosure.

FIG. 15 illustrates a method for collecting RIS information, in accordance with embodiments of the present disclosure.

FIG. 16 illustrates RIS reflective elements required to provide a certain amount of capacity at two different grids, in accordance with embodiments of the present disclosure.

FIG. 17 illustrates a multi-hop RIS communication system, in accordance with embodiments of the present disclosure.

FIG. 18 illustrates a multi-hop RIS communication system, in accordance with embodiments of the present disclosure.

FIG. 19 illustrates distributed C&C with a base station or a set of base stations organizing the C&C process, in accordance with embodiments of the present disclosure

FIG. 20 illustrates distributed C&C without pre-configuration, in accordance with embodiments of the present disclosure.

FIG. 21 illustrates a method for configuring reconfigurable intelligent surfaces (RISs) to support network service, in accordance with embodiments of the present disclosure.

FIG. 22 defines the content and details of the initial C&C query request message, in accordance with embodiments.

FIG. 23 defines the content and details of the C&C query response message, in accordance with embodiments.

FIG. 24 is a schematic diagram of an electronic device, according to embodiments of the present disclosure.

It will be noted that throughout the appended drawings, like features are identified by like reference numerals.

### DETAILED DESCRIPTION

The present disclosure provides a method and apparatus for configuring reconfigurable intelligent surfaces (RISs) to support network service. According to embodiments, there are provided centralized, distributed and hybrid methods for determining a set of base stations that can be responsible for control and communication (C&C) of RIS. In particular, there are provided RIS C&C architectures, RIS-specific messaging protocols in various scenarios, and a grid-based method for facilitation of RIS related analysis.

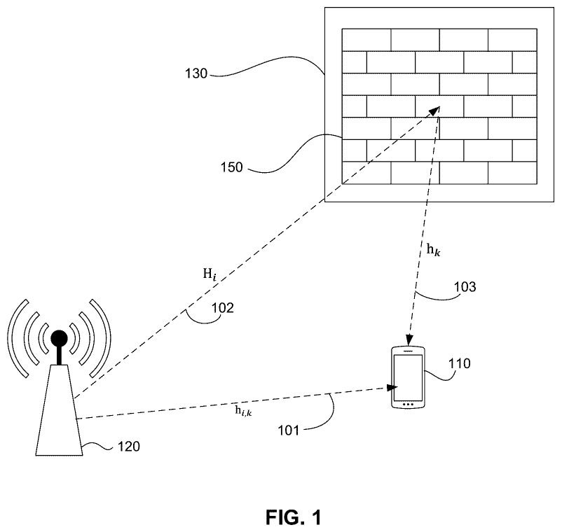

FIG. 1 illustrates a RIS system deployed on a façade of a building. Referring to FIG. 1, the user 110 receives wireless signals directly from the base station (transmitter) 120 as indicated by the arrow 101. Alternatively, the user 110 may receive signals indirectly from the base station (BS) 120 through the RIS 150 deployed on the surface of the building 130. The wireless signal hits the surface of the building and is reflected to the user 110, as indicated by the arrows 102 and 103. While not illustrated in FIG. 1, there can be multiple base stations and multiple users that transmit and receive signals using the RIS 150 in the surrounding environment.

The RIS 150 may be a multiple-input-single-output (MISO) system with M reflectors. Provided that i indicates the base station (BS) 120 with Ni antennas, the composite channel for the user k can be sensed of defined as follows:

$${h}_{i , k , Φ} = {H}_{i} Φ {h}_{k} + {h}_{i , k}$$

In the mathematic equation above, Hᵢ represents C^{N}^{ᵢ}^{×M} channels between the RIS 150 and the base station (BS) i (base station 120 in FIG. 1), Φ represents the phase shift array of the RIS 150 (e.g. Φ=[p₁e^{jΦ}^{₁}, . . . p_{M}e^{jΦ}^{_{M}}]), hₖ represents the path between the user k and the RIS 150, and h_{i,k} represents the direct path between the user k and the base station i (base station 120 in FIG. 1).

As noted above, existing RIS technologies and studies focus on utilization of RIS, for example how channel sensing can be performed and how RIS configuration can be derived, or how the RIS can be used to enhance radio access network (RAN) communications. However, existing RIS technologies and studies have not explored how to control or configure RIS in the network. For example, issues like which resources will be used for RIS control links, which base stations will be responsible for channel sensing and deriving RIS configurations, and whether RIS configuration is performed in a centralized or distributed manner have not been properly addressed. It has been realised that there needs to be further investigation with respect to RIS control, which can include:
Provided that RIS is formed of a large number of reflective elements (e.g. reflectors), it can be challenging to retain a sufficient number of pilot signals for channel sensing, and therefore effective management is needed.
Although phase shift array of the RIS needs to be configured and provided to the RIS controller, for current RIS technologies there is no identification of who is responsible for the control, communication and computation. This can become more critical when joint passive and active beamforming is considered.
Current RIS technologies do not provide any solution for “heterogeneous RIS deployments” (i.e. the deployments that involve multiple RISs with a varying number of reflective elements (e.g. reflectors, tiles) and properties). This can be considered in all aspects including run time and management.

The present disclosure addresses one or more of the above issues in consideration of capabilities and demands of wireless networks. Various embodiments of the present disclosure render effective RIS control and configurations in various settings and environments. In particular, there is provided a method for determining a set of base stations used for control and communications (C&C) of RIS deployments. It is noted that these set of base stations may utilize the RIS deployments or may be only responsible for C&C of RIS deployments.

In the context of control and communications (C&C) of RIS deployments, “control” corresponds to the calculations, analysis, optimization and other relevant operations to configure RIS including setting power and angle(s) for reflective elements of RIS (e.g. reflectors, tiles) and sharing mode of operation (e.g. absorb, reflect) depending on the type of RIS deployment. “Communication” includes communication with the RIS controller. There can be one or more RIS controllers per RIS deployment, depending on the type and complexity of the deployment. The communication can also include communication with RIS managers and providers. RIS managers and providers can be associated with one or more RIS deployments. It is noted that base stations and other network elements (e.g. central manager) may be responsible for control and communication of the RIS deployments. The communication between various elements can be performed via wired or wireless links.

According to embodiments, a RIS C&C set, which includes a set of base stations responsible for C&C of RIS deployments, can be determined in a centralized or distributed manner. The centralized method can be used to preconfigure the network in order to address RIS C&C requirements. The pre-configuration may include provisioning of an RIS C&C slice. The distributed method can be used to adaptively deal with C&C requirements and maximize usage of the network edge, for example locations wherein a device or local network interfaces communication network. Various embodiments, for both the centralized method and distributed method include fully centralized/distributed approaches and hybrid approaches. Both centralized and distributed methods may include different RIS discovery procedures for initial discovery of RIS deployments.

According to embodiments, RIS information is collected to facilitate RIS analysis using a grid-based approach, for example in the course of RIS C&C set determination, wherein a RIS C&C set can be a set of base stations responsible for C&C of RIS deployments. The grid-based approach can allow effective representation of the network capacity (e.g. peak data rate, spectral efficiency, spectral energy or any combination thereof) and can provide programmability or re-configurability of the RIS.

It is noted that, in various embodiments provided in the present disclosure, there is a mobile network operator (MNO) that owns base stations and a central manager (CM) (e.g. for operations, administration and management (OAM)). The MNO may be responsible for one or more of the RIS deployments and therefore has full information about these RIS deployments. The MNO may utilize some other RIS deployments of which it does not have full information. The MNO may be triggered to determine the set of base stations for C&C of the RIS deployments when the MNO receives a service request or needs to use the RIS deployments to address service requirements.

It is noted that, in various embodiments provided in the present disclosure, an RIS controller is considered a network element, such as a special user equipment (UE). As a network element, the RIS controller can connect to a network in a manner similar to how UE connects to network. For example, when the device type of the network element is indicative of a RIS controller with an RIS identifier (ID), this information may be used by one or more base stations for communication with the RIS controller. Once an RIS is deployed based on a suitability criterion, for example the RIS ability to cover the one or more users in a hot-spot, the RIS controller needs to establish one or more connections with the one or more base stations that perform the C&C. When the RIS controller communicates as a UE, the RIS controller will search for the one or more base stations that have sufficient signal reception and subsequently send a connection establishment request to these particular base stations in order to obtain the locations of the base stations and to verify whether these base stations would be able to act as a C&C by obtaining base station information related to C&C from these base stations. If a BS is able to act as a C&C the RIS controller is capable of determining the areas that can be served by the RIS knowing the relative location between the RIS and the BS. This information related to C&C is provided to the base station as part of the RIS information in order that base station can use this information in order to perform C&C when serving the users in that coverage area, for example related to the suitability criterion.

At least some methods and apparatuses disclosed herein can be operable even if the RIS controller is not connected to the core network as a network element, and can be considered to be a stand-alone device. For example, the way the RIS controller is represented within the network does not change the convergence criteria or messages exchanged between base stations with regard to channel sensing, computational power or other shared information associated with the RIS controller. The only differences, in the case of a non-registered RIS controller (e.g. an RIS controller without network connection), would be that the RIS IDs and RIS objects are not used and only channel state and grid-based information are exchanged.

### Centralized/Pre-Configured RIS C&C Set Determination

According to embodiments, a RIS C&C set, which includes a set of base stations responsible for control and configuration (C&C) of RIS deployments, is determined. In various embodiments, the C&C of RIS deployments includes calculation of active and passive beamforming matrices, channel sensing for RIS and base stations and communication with the RIS controller to configure reflective elements of the RIS. In various embodiments, base stations control and configure one or more reflective elements of the RIS for which each base station is responsible. Each RIS deployment needs to be identified using a specific identifier. For example, the RIS may be identified using a designated RIS identifier (ID) or provided internet protocol (IP) address.

According to embodiments, an RIS object can be defined in the network management system. The RIS object includes various information, such as RIS identification, RIS location, RIS deployment type, number of reflective elements (e.g. reflectors, tiles), types of reflective elements, IDs of reflective elements, RIS controller specification, RIS pilot signal information, RIS abstraction and interface information, RIS owner, RIS malfunction information (e.g. information indicative of whether some of the reflective elements are damaged), RIS service area information (e.g. grid-based catalogue as illustrated below), RIS channel sensing information, and any additional information that may be required to describe and utilize the RIS. Some of the above information can replace some messages used in the processes illustrated in the present disclosure. In various embodiments, the RIS object can be shared among network entities (e.g. central manager (CM), access and mobility management function (AMF), base stations), can be provided by the RIS provider, although the RIS provider may not expose the full information of the RIS object.

According to embodiments, a set of base stations responsible for control and configuration (C&C) of RIS deployments (RIS C&C set) can be determined in a centralized (pre-configured) or distributed manner.

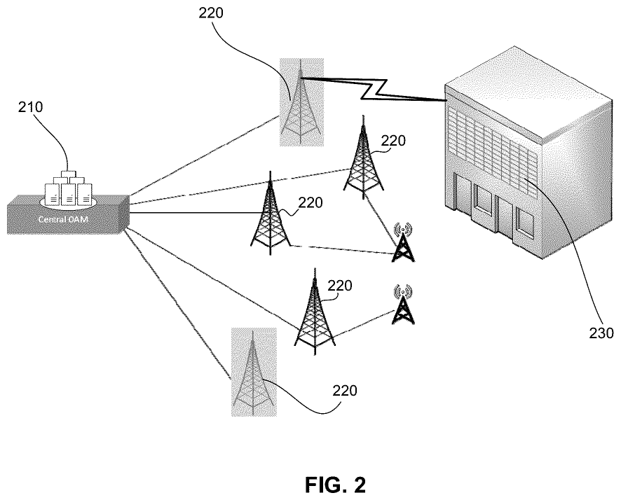

In the case of the centralized (pre-configured) determination, upon configuration of the network (e.g. by the network manager (NM)), a set of base stations responsible for C&C of RIS deployments (RIS C&C set) is determined by a centralized network entity, for example a central manager (CM; e.g. central operations, administration and management (central OAM)) or a (central) network manager (e.g. network slice management function (NSMF), network slice subnet management functions (NSSMF)). FIG. 2 illustrates an example of centralized selection of RIS control and communication (C&C) set, in accordance with embodiments of the present disclosure. With reference to FIG. 2, various access nodes 220 (e.g. base stations) send their data and other RIS-specific information to the central OAM 210, and the OAM 210 determines a set of base stations responsible for C&C of the RIS 230 (RIS C&C set) based upon received data and information.

According to embodiments, the RIS C&C set can be determined in consideration of various factors, for example, proximity to RIS, channel quality, RIS usage, services to be provided using the RISs, computational power, and expected network traffic in the areas covered by the base stations. Further is illustrated below with regards to these considering factors for determining the RIS C&C set.

According to embodiments, CM or NM considers physical proximity of base stations to each RIS unit. In particular, the physical proximity is useful if channel sensing information is unavailable when the network is being configured. As the physical proximity of base stations to RIS units does not guarantee quality of the channels between base stations and RIS units, a central manager (CM; e.g. central operations, administration and management (central OAM)) or a (central) network manager (e.g. network slice management function (NSMF), network slice subnet management functions (NSSMF)) updates the RIS C&C set upon receipt of the channel sensing information from base stations.

The RIS C&C set may be determined based on quality of the channel between each base station and other base stations and between each base station and RISs (or RIS units). One indicator of the channel quality is spectral efficiency which is indicative of estimated resources required for a unit of communications with the RIS controller or other network entities. In some embodiments, the channel quality information obtained from a base station may include channel information between the central unit (CU), distributed unit (DU), RIS or any combination thereof. For example, a CU may inform of only the best DU-RIS channel or all of DU-RIS channels and CU-RIS channel.

The RIS C&C set may be determined based on RIS usage. The base stations that need to use RIS the most (e.g. base stations with the most frequent RIS usage) can be responsible for RIS C&C, and therefore included in the RIS C&C set.

The RIS C&C set may be determined based on services to be provided using RISs. In some embodiments, the responsibility for C&C of RISs may be distributed based on the services that will be using RISs. For instance, in the case that a subset of base stations provides positioning services and some other subset of base stations attempts to improve the aggregate rate of communications, base stations can be grouped based on their purpose of RIS usage. Further, RIS resources may be even pre-allocated to some services based on the purpose of the RIS usage. In this case, each base station subset is responsible for configuration of the reflective elements allocated thereto for its service.

The RIS C&C set may be determined based on computational power of the base stations. Provided that tasks like active and passive beamforming and channel sensing can be computationally intense, some base stations may be selected as the RIS C&C set and become responsible for C&C of the RIS, when they have sufficient computational resources available. These base stations may be remotely located from the location of the RIS or may not utilize the RIS for their own services. Regardless, the base stations may be utilized as edge-computing nodes. In some embodiments, some base stations in the RIS C&C set may be mainly responsible for computation and some other base stations in the RIS C&C set may be generally responsible for communication. Such configuration may be determined based on availability of computation and access resources. In some embodiments, the base stations responsible for computation may also have access to cloud services or non-terrestrial nodes (e.g. high-altitude platform station (HAPS)), therefore can assist them to complete computational tasks.

In some embodiments, distributed learning algorithms may be used and the nodes, for this purpose, can be grouped based on their computational capacities. For instance, nodes with high computational power can be grouped with nodes with low computational power, and in effect, nodes in all groups would complete the task, practically at the same time. Alternatively, nodes with high computational power form one group to obtain some results as quickly as possible, whereas other nodes with lower computational power are loaded with either simpler tasks or less urgent tasks. For example, prediction for the future time periods is not an urgent task and therefore can be loaded to nodes with low computation capacity. On the other hand, joint active and passive beamforming for the next communication time window (next time period or next scheduling interval) is an urgent task and therefore loaded to nodes with high computation capacity in order to support the computations required for the joint active and passive beamforming task.

The RIS C&C set may be determined based on expected network traffic in the areas covered by the base stations.

For moving base stations (e.g. drone base station or other base station(s) moving on the ground), further information may need to be considered when determining RIS C&C set. The further information to be considered can include the proximity of travel, remaining battery, other services requiring the moving base station, computational power of the moving base station, swarming, available fronthaul and backhaul services, available communication capacity (access resources) and a grid-based analysis. These are further discussed below:
Proximity to travel: If a moving base station is to be used near the RIS, proximity to travel is considered for the RIS C&C set selection. While proximity to travel alone may not be sufficient for selection of a (certain) moving base station, it may be considered for the RIS C&C selection, in combination with other factors, such as remaining battery, available computational resources, network entities (e.g. services, users, access nodes) currently using that moving base station.
Remaining battery: In some embodiments, C&C of RIS may consume battery of a moving base station, as since it may require computation and communication with other moving base stations, RIS controller or terrestrial base stations. For example, when considering for RIS C&C demand, a moving base station with low remaining battery or estimated to have insufficient battery amount would not be selected for the RIS C&C set. Such moving base station will not be asked to take responsibility for RIS C&C, even if it satisfies other requirements.
Other services requiring the moving base station: If, for example, a certain moving base station is providing services and its association with RIS C&C can cause disruption on the services that it is providing, then that moving base station would not be selected for provision of RIS-related services.
Computational power of the moving base station: For example, moving base stations with high computational power would be selected for computation heavy tasks, and moving base stations with low computational power would be utilized only for communications or tasks related to communication.
Swarming: Provided that multiple moving base stations may be used for C&C of RIS, each base station may be responsible for different tasks. For instance, one moving base station is responsible for computation, and another moving base station is responsible for controlling communication. For communications during RIS C&C, moving base stations can utilize the high capacity line of sight (LoS) links between base stations and between base station and RIS at higher frequencies including mmWave and THz.
Available backhaul and fronthaul resources: Available backhaul and fronthaul resources are particularly important when a moving base station is acting as a distributed unit (DU) and/or is sharing C&C responsibility with a terrestrial base station. In this case, available backhaul and fronthaul resources must be sufficient to perform RIS-related tasks without disturbing other services using the moving base station or the terrestrial base station. The moving base station may be connected to the terrestrial base station for backhaul, even if the moving base station is not originally responsible for RIS C&C, for example because the moving base station outside of the area covered by the RIS or good communication link is not well established between the moving base station and the RIS. However, the moving base station may connect to a certain terrestrial base station for backhauling or fronthauling, if the terrestrial base station has better resource availability than other ones. For example, there is less traffic in the coverage of the terrestrial base station, there is no demanding service using the terrestrial base station, other base stations are malfunctioning, or other base stations suffer from congestion. In this case, the base station that was not previously responsible becomes responsible for RIS C&C indirectly.
Available communication capacity (access resources)
Grid-based analysis

For UEs, the UEs in the network may be selected to obtain sensing information, to utilize their computation power and to communicate with the controller. Usage of UEs to help network may involve incentives, which may be monetary or not. The UEs may need to satisfy certain trust requirements. Regarding multi-hop scenarios, UEs may use device-to-device (D2D) links to access the RIS controller, other RIS nodes, and/or moving access points and so on.

For other internet-of-things (IoT) or sensing devices, these devices may be selected for performing or supporting various computational tasks.

As stated above, according to embodiments, a RIS C&C set can be determined in a distributed manner. In the distributed method, a central unit (CU) may configure its distributed units (DUs) for RIS C&C.

In some embodiments, the CU transfers all of its responsibility to DU, including computation and communication with other responsible base stations and the central units (CUs) and/or distributed units (DUs).

In some other embodiments, the CU partially transfers responsibility to DU. For example, upon partial transfer of the responsibility, DU becomes responsible for communication with the RIS controller and channel sensing for RIS. Then, the CU is only responsible for coordination with other units and computation of algorithms. Computation of algorithms may include one or more of distributed learning methods, edge computing, cloud computing and fog computing.

In some other embodiments, the CU distributes all of its responsibilities to multiple DUs. For example, upon partial transfer of the responsibility, DU becomes responsible for communication with the RIS controller and channel sensing for RIS. In addition, DUs can take further responsibilities. For example, multiple DUs take responsibility for channel sensing and share results with the CU or DU that is responsible for computation of the channel. Alternatively, for example, a first set of DUs takes responsibility for channel sensing and a second set of DUs take responsibility for communications with the RIS controller, and a third set of DUs take responsibility for collaboration with other base stations and units. Configurations of the DU sets and all of their actions are performed by the base station. It is noted that some DUs may be in more than one set (e.g. a DU is in the first set and the second set and take responsibilities for both channel sensing and communications with the RIS controllers).

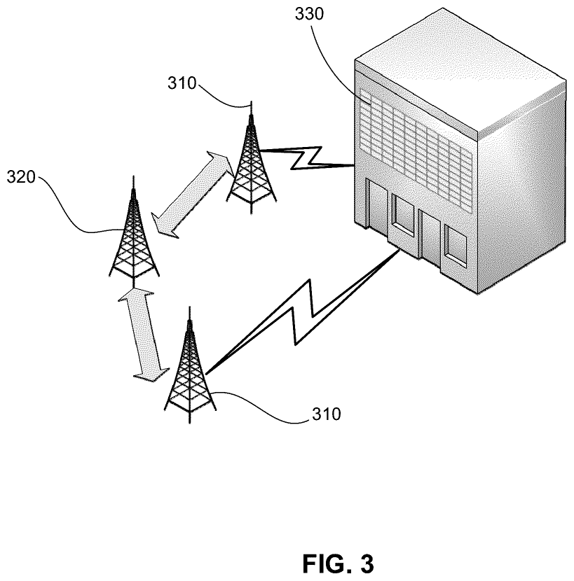

FIG. 3 illustrates an example control of distributed RIS C&C set selection, in accordance with embodiments of the present disclosure. As illustrated in FIG. 3, the base stations 310 and 320 communicate with each other. The selected base stations 310 communicate with the RIS 330. The selected base stations 310 are responsible for communication with the RIS controller and channel sensing for the RIS 330.

According to embodiments, various combination of the considering factors listed above for RIS C&C set selection can be used to determine a set of base stations responsible for RIS C&C. For instance, a multi-objective optimization parameter can be formulated to address multiple considering factors for RIS C&C set selection. For another instance, a learning-based approach may be established to have reward/quality functions (e.g. Q-learning) based on one or more of the above considering factors. Each considering factors may be weighed equally or differently, depending on circumstance.

The RIS C&C sets may be updated in consideration of the above considering factors thereby retaining one or more network benefits at a desired level. The network benefits may include one or more of quality of service (QOS) of users, cost of services, traffic rate, latency, number of users that can be served, network outage probability, network load distribution, efficient usage of multi-domain network resources, and network security (e.g. jamming against adversarial users via RIS).

In various embodiments, a pre-configured RIS configuration slice can be provisioned in consideration of the above considering factors as well as remaining network resources in other network domains (e.g. core network (CN) and transport network (TN)). The pre-configured RIS configuration slice may be provisioned in consideration historical data to estimate the required resources for RIS (C&C). The pre-configured RIS configuration slice can be also provisioned for RIS with multi-tenancy where, for example, different operators, network slices or network services share the RISs with varying levels of rights in respect of information access and RIS elements control.

The pre-configured RIS configuration slice can be regularly assessed in light of RIS performance and updated to enhance the RIS performance. The updates may depend on factors like future network traffic prediction and network service requirements. For instance, if it is expected that one of the base stations in the RIS C&C set becomes congested, that base station may be replaced with one or more other base stations in the RIS C&C set, including non-terrestrial nodes.

### Pre-Configured RIS C&C Set Selection

In embodiments where the RIS C&C set is selected in a centralized manner (pre-configured RIS C&C set selection), the network manager (NM) includes network slice management function (NSMF), network slice subnet management functions (NSSMF) or other similar network management functions. In some embodiments, the NSMF and NSSMF operate as a single entity. In some embodiments, the NSSMF operate as a domain manager. Here, the NSMF and NSSMF provide a pre-configured RIS control slice which includes at least one set of access points serving at least one RIS deployment. Furthermore, the NSSMF may be RAN NSSMF, or any other manager of the RAN subnet or similar network segment. In some embodiments, the NSSMF includes subnet(s) with RAN and CN components as well.

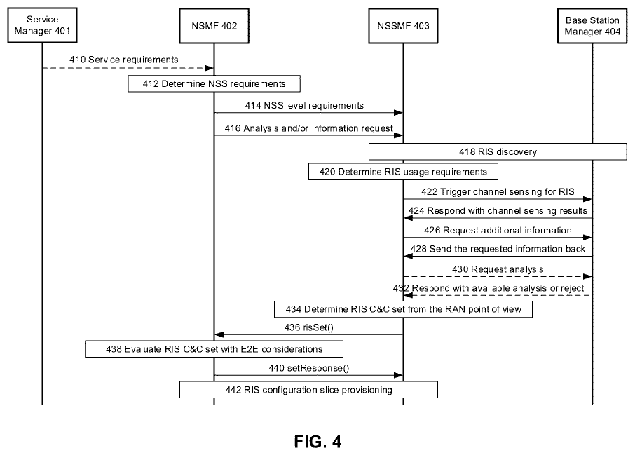

FIG. 4 illustrates a process 400 of centralized RIS C&C set derivation with NSMF and NSSMF, in accordance with embodiments of the present disclosure. Referring to FIG. 4, the NSMF 402, at step 410, receives service requirements from the service manager 401. The service manager 401 may be a communication service management function (CSMF). The service requirements may be received for a communication service (e.g. enhanced mobile broadband (eMBB), internet-of-things (IoT), etc.) or an RIS-as-a-service type service request.

The NSMF 402, at step 412, determines network slice selection (NSS) level requirements. The process of determining NSS level requirements depends on the type of received service request. In the case of communication service request, the NSMF 402 determines the communication needs by portioning them into network slice subnet instance (NSSI) level and determines, together with the NSSMF 403, whether the RIS will be used or not. This may lead to provisioning of an RIS C&C slice in addition to the communication service slice. Alternatively, RIS C&C may be provisioned as a part of the communication service slice, for example eMBB slice. In the case of RIS-as-a-service request, RIS will be used and an RIS C&C slice will be provided. The service requirements may include frequency of the RIS reconfiguration (i.e. how often the RIS needs to be reconfigured), the number of reflective elements in the RIS, communication capacity of RIS controller, RIS ID or any combination thereof.

Upon deriving the NSS level requirements, the NSMF 402 sends these requirements at step 414 to the NSSMF 403 and additionally sends an analysis and/or information request 416 to the NSMF 403. Then the NSSMF and the base station manager 404 begin a RIS discovery process 418. The RIS discovery process is used to establish the communication link between the RIS controller and the base station manager, and to exchange information regarding RIS characteristics and services available to the base station. The RIS discovery process can be performed in-band or out-of-band. When the RIS discovery process is completed, the NSSMF 403 determines the RIS usage requirements 420 and the NSSMF 403 at step 422 triggers the channel sensing process. During the channel sensing process, the base station may sense the BS-RIS link or the cascaded channel (e.g. BS-RIS-UE). The BS-RIS link may be a communication link between the base stations and the set of RISs requiring C&C. The cascaded channels may be channels between the base stations, the set of RISs requiring C&C and a terminal device (e.g. UE). The base station manager 404 subsequently responds to the NSSMF 403 with the channel sensing results. The NSSMF 403 may request additional information 426 and upon receipt of the requested additional information 426. The NSSMF 403 may also request further analysis 430 from the base station manager 404 in order to determine the RIS C&C set. The base station manager 404 may respond with the available (or further) analysis or reject this request 432. When the C&C set is determined 434 by the NSSMF, the C&C set is sent to the NSMF 402 through the message risSet ( ) 436. The NSMF 402 then evaluates 438 the derived RIS C&C to determine if the derived RIS C&C set satisfies the E2E requirements. The NSMF 402 subsequently sends a response to the SSMF 403 with the setResponse ( ) 440. At this stage, the RIS configuration slice can be provisioned 442.

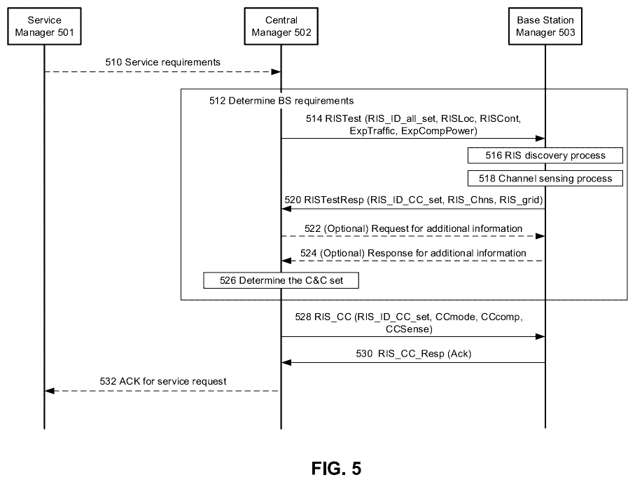

FIG. 5 illustrates a process 500 of RIS C&C by a central manager, in accordance with embodiments of the present disclosure. Referring to FIG. 5, a central manager (CM) 502, at step 510, receives service requirements from the service manager (SM) 501. The received service requirements may be requirements for an RIS-as-a-service type service or another type of RIS service. The other type(s) of RIS service may need to satisfy requirements of one or more different kinds of services, for example eMBB and intelligent transportation system (ITS).

The CM 502, at step 512, determines requirements for one or more base stations to provide C&C of RIS deployments (RIS C&C).

Then, the CM 502 sends, at step 514, a RIS information request (e.g. RISTest ( ) message) to the base station managers 503 in order to determine capability of the base stations to provide RIS C&C.

In some embodiments, the RIS information request may not be required if a catalogue is previously obtained. The catalogue may include information indicative of cost for RIS communication (e.g. communication between RIS and base stations) and benefit(s) from the RIS deployment (e.g. coverage extension, mobility management improvement, mobility rate improvement).

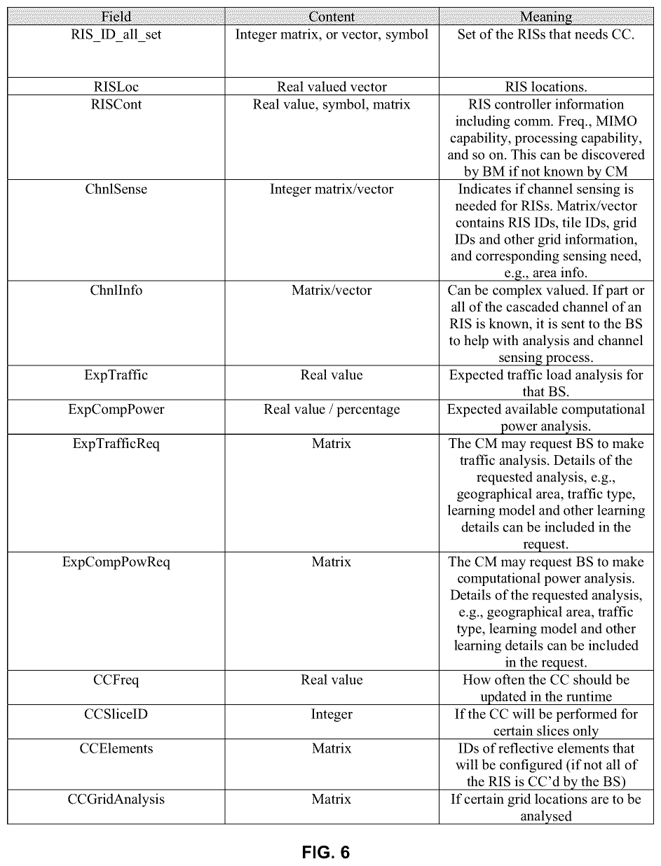

According to embodiments, the content and details relating to the RIS information request is provided in FIG. 6.

The RIS information request may include information indicative of a set of RISs requiring C&C (e.g. RIS IDs of some or all of the RISs in the service region). If (previous) information about links between RIS and base stations is available for some RISs, their RIS IDs may be omitted. The information about links between RIS and base stations may be obtained by historical analysis, LoS analysis, or channel sensing.

The base station uses the RIS IDs during the RIS discovery process and gathers required analysis (e.g. channel quality, RIS coverage, estimate of required computational power). The RIS information request (e.g. RISTest ( ) message) is sent to obtain RIS information indicative of characteristics of the RIS (e.g. number of reflective elements of the RIS). Alternatively, characteristics of the RIS may be obtained from the RIS controller during RIS discovery process.

Information indicative of the number of reflective elements of the RIS does not have to contain the number of entire reflected elements. Instead, the information may only represent the elements allocated for a particular service provider, service, slice, area, or geographical location. Similar to the RIS ID of the RIS (entire surface), each reflective element of the RIS can have an ID, which is reachable by the base station and may be shared with only that base station. In some embodiments the IDs of reflective elements may be configured by the CM 502 as a part of the RIS information request (e.g. RISTest ( ). For example, the reflective element IDs are included in the RIS ID matrix for each RIS. Alternatively, the IDs of reflective elements may be obtained from the base station, for example by communicating with the RIS controller. The base station may inform the CM 502 of the RIS IDs and the IDs of the reflective elements that the base station can perform C&C.

In order to support the analysis and discovery of the base station, the CM 502 may share the expected network traffic and expected available computation power of the base station with the associated network devices including base stations and RIS controllers.

Optionally, the CM 502 requests analysis in respect of the expected network traffic and expected available computational power of the base station from the base stations. The base station may perform the requested analysis by itself or in cooperation with an artificial intelligence (AI) of RAN. The base station may request more information about the required analysis, for example the coverage area and grid IDs. If distributed learning is being used to estimate the network traffic and computational load, the base station may request models, features, group information (for the base stations in the same learning group), learning type (e.g. federated, swarm, transfer) and other learning related information. In some embodiments, the learning settings may be included in the analysis request message.

The CM 502 may request the channel sensing process for some or all of the RISs using the field in the RIS information request message (e.g. ChnlSense in FIG. 6). In some embodiments, the CM 502 may use this field to indicate that the CM 502 does not request the channel sensing process for the RISs. The CM 502 may share if some or all of the cascaded channels are known. The cascaded channel normally includes of a link between the base station and RIS (BS-RIS link), and another link between the RIS and UE (RIS-UE link), each link configured for uplink (UL) or downlink (DL) or a link configured for DL and reverses for UL. For example, a DL can be defined as being from the BS to the RIS to the UE, or a DL can be defined as from the UE to the RIS to the BS. As such, a cascaded channel may be referred to as BS-RIS-UE or UE-RIS-BS. In some embodiments, the cascaded channel may include multiple RIS hops (e.g. BS-RIS_1, RIS_1-RIS_2, . . . , RIS_(K-1)-RIS_K, RIS_K-UE). In some embodiments, the cascaded channel includes a mix of hops (e.g. BS_1-BS_2, BS_2-RIS_1, RIS_1-RIS_2, RIS_2-UE). It should be noted that the cascaded channel can also include D2D communications. Moreover, the UE may simply correspond to a geographical location (e.g. sensed grid or area). If the UE is a grid or area, the channel sensing information can also include grid ID or area ID or any information indicative of the specific relevant location.

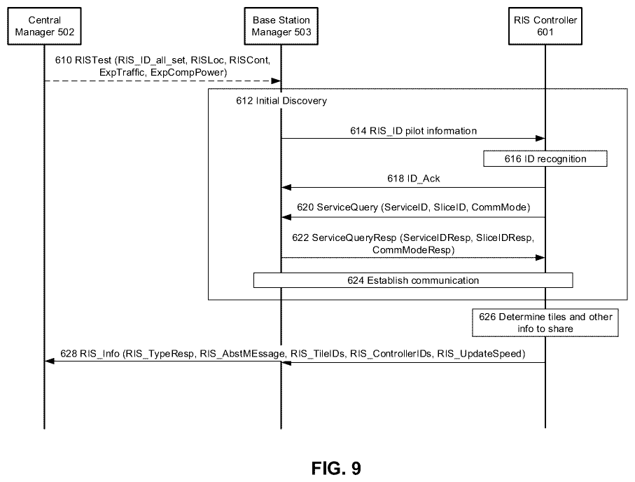

At step 516, the base station manager 503 performs the RIS discovery process. It is noted that part of the RIS discovery process is illustrated above and further about the RIS discovery process is illustrated elsewhere in the present disclosure (e.g. FIG. 9). During the RIS discovery process, the base station tries to communicate with each RIS controller. The RIS may receive an ACK or NACK from RIS controllers in respect of the process. The base station may check one or more of the LoS information, RIS location and RIS controller information for further derivation, for example to determine whether the RIS is located within the service area.

At step 518, the base station manager 503 performs the channel sensing process. During the channel sensing process, the base station may sense the BS-RIS link or the cascaded channel (e.g. BS-RIS-UE). The BS-RIS link may be a communication link between the base stations and the set of RISs requiring C&C. The cascade channels may be channels between the base stations, the set of RISs requiring C&C and a terminal device (e.g. UE). The cascaded channel is further illustrated above and elsewhere in the present disclosure.

In response to the RIS information request sent by the CM 502, the base station manager 503, at step 520, sends RIS information to facilitate RIS related analysis. The received RIS information may include information of one or more configurable RISs of which each base station is able to perform C&C. The RIS information may be sent to the CM 502 via a RIS information response like RISTestResp ( ) In some embodiments, each base station directly responds to the CM 502.

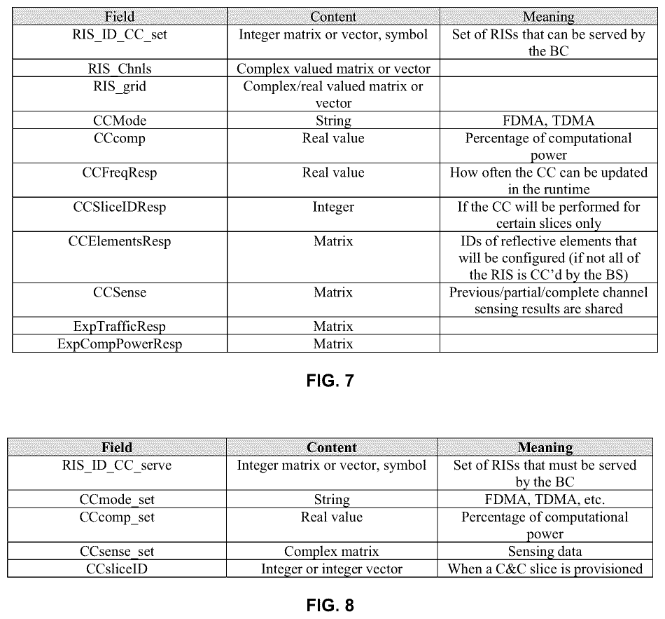

According to embodiments, the content and details of the RIS information response is provided in FIG. 7.

The RIS information response includes a set of RISs that the base station can perform C&C. If the base station is involved with any part of the cascaded channel as illustrated above or has previously performed the channel sensing process, the base station may share those results to facilitate analysis of the CM 502 and other base stations (e.g. base stations included in the RIS_Chnls field of the RISTestResp ( ) message). The field including the base stations (e.g. RIS_Chnls) may contain RIS ID, base station ID, UE ID, and corresponding channel sensing analysis (e.g. geographical area, grid ID, tile ID). If the base station has any information (e.g. channel sensing, measurement) about the grids, the base station shares the information with the geographical area corresponding grid ID. If the grid analysis is requested by the CM 502 and the base station performs the analysis, the analysis result is sent for example via RIS_grid field.

The base station may be responsible for the C&C requirements of a certain set of network slices or network services. The RIS resources may be allocated to different slices in time, for example in terms of RIS deployments or a certain part of an RIS deployment. Then, only the related analysis and channel sensing are conducted by the base station.

The base station may not be responsible to C&C of the entire RIS (e.g. all reflective elements thereon) but may be responsible for only part of the RIS (e.g. a certain set of reflective elements thereon). This can be helpful for multi-tenancy and the circumstance explained above.

The RIS information response from the base station to the CM 502 includes an ACK or NACK, and analysis results if they are conducted by the base stations.

The CM 502, at step 522, may send a request for additional information to the base station manager 503. The requested additional information is not necessarily RIS specific but is any information useful for analysis and other related processes. This includes one or more of information related to performance management (PM), CM data, analysis by base station manager-AI or RAN-AI engines/managers, location/area specific statistics, outage probabilities, and services utilizing the base station. Some of the additional information may be obtained by the core network via core network managers and functions.

The CM 502, at step 524, may receive the responses to the additional information requests from the base station manager 503. It should be noted that not all base stations may provide the same information. For instance, if one base station belongs to a different provider (e.g. MNO or infrastructure provider), not all of the information may be shared with the requesting CM 502.

The CM 502 (central network entity), at step 526, may determine a RIS C&C set based on the received information and analysis, which may indicate one or more characteristics of each base station. The RIS C&C set may include one or more base stations responsible for C&C of RIS deployments. The characteristics of each base station may include proximity to the RISs, channel quality, RIS usage, services to be provided using the RISs, computational power and expected network traffic in the area covered by the base station.

In some embodiments, determining the RIS C&C set may require additional communications with artificial intelligence (AI) engines at different levels. Such AIs may include central and domain AIs as well as AIs of other providers in cases of multi-tenancy or distributed learning. Furthermore, if available, digital twins of base stations and other entities may be utilized to facilitate the analysis and the information collection procedures described above. Further will be illustrated below and elsewhere in the present disclosure in respect of a grid and AI based method to facilitate C&C set definition.

The CM 502, at step 528, sends a message for RIS C&C (e.g. RIS_CC message) to the base station manager 503. The RIS C&C message includes the configurations for base stations for RIS C&C. Based on the analysis on network traffic, (available) computation power, channel state and other relevant information, the update frequency (e.g. how often the base station updates C&C) may be determined. These values may be set by the CM 502 based on historical analysis. The CM 502 may set these values further based on run-time measurements upon activation of the RIS service/slice. The update frequency can assist for planning distributed learning processes. However, if there is a trigger for update (e.g. decrease on performance decrease), the update does not need to wait for the specified time (e.g. update period).

According to embodiments, the content and details of the RIS C&C message, in this case RIS_CC message, is provided in FIG. 8.

Further it will be illustrated below with respect of the RIS_CC message provided in FIG. 8.
RIS_ID_CC_serve includes the ID of the RIS (e.g. RIS_ID) to be served, IDs of the set of reflective elements/tile of the RIS to be served, and surface area indicator of the RIS to be served by the base station. The portion to be served by the base station can be determined based on one or more of service type, tenancy (e.g. RIS may be shared among MNOs), communication service requirements, and computational power.
CCmode_set indicates the multiplexing method to be used. The value for CCmode_set can be chosen among available types (e.g. depending on capabilities of the controller and BSs). The value for CCmode_set can determined based on one or more of resources, other services using the base stations, computation needs, and required update frequency.
CCsense_set includes any sensing information that can help the base station to determine passive and active beamforming matrices. For instance, CCsense_set can include historical channel sensing data.
CCsliceID may be useful when a C&C slice(s) is provisioned

The base station manager 503, at step 530, sends to the CM 502 a response to the message for RIS C&C (e.g. RIS_CC message). The response may include acknowledgement of receipt (e.g. ACK or NACK). Based on the received acknowledgement, the CM 502, at step 532, sends to the service manager 501 an acknowledgement for the service request.

### Channel Sensing for Pre-Configuration

According to embodiments, the base station and the RIS controller need to communicate for channel sensing (e.g. channel sensing at step 518 of FIG. 5). If the base station has not yet established communications with at least one of the RISs or the RIS controller of at least one of the RISs in the RIS set to be served, a discovery process is triggered prior to the channel sensing. The discovery process is used to establish the communication link between the RIS controller and the base station manager, and to exchange information regarding RIS characteristics and services available to the base station. The RIS discovery can be performed in-band or out-of-band.

According to embodiments, some RIS deployments may be more complex than others (e.g. software defined metasurfaces with several internal controllers, and a common interface connecting the internal controllers to other devices). Such RIS deployments may also provide varying levels of abstraction. For instance, instead of setting the tile (reflective element) parameters for each wave, RIS may be provided with a command to absorb the wave. This type of specification of RIS deployments can be a part of the discovery process.

The RIS discovery process can take place between the CM and base station manager and between the base station manager and RIS controller, as illustrated in FIG. 9. FIG. 9 illustrates an RIS discovery process 600, in accordance with embodiments of the present disclosure.

As illustrated in FIG. 9, the RIS discovery process 600 can be initiated upon receiving a set of RIS_IDs from the CM 502.

At step 610, the CM 502 sends a RIS information request (e.g. RISTest ( ) message) to the base station manager 503. Step 610 is substantially equivalent to the step 514 of FIG. 5. The discovery process may be triggered by the RIS information request message request (e.g. RISTest ( ) message) as specified in FIG. 9. However, in at least some embodiments, the discovery process can take place according to a (predetermined) schedule, or can be triggered by other event(s), such as performance degradation (e.g. increase on outage rate, increase on mobility of users).

At step 612, the initial discovery process begins. The initial discovery process is only necessary if the base station manager 503 is not configured to communicate with the RIS controller 601. If the RIS controller 601 had established communications with CM 502 or the base station manager 503, the initial discovery process may not be needed.

If the RIS controller 601 and the base station manager 503 have not communicated previously (i.e. communication between the RIS controller 601 and the base station manager 503 have not been established), the base station manager 503, at step 614, initiates the RIS ID based pilot transmission. The initial discovery or initial communication between the RIS controller 601 and the base station manager 503 may occur in-band or out-of-band.

At step 616, the RIS controller 601 recognizes the RIS ID.

At step 618, the RIS controller 601 sends an acknowledgement back to the base station manager 503 for acknowledgement of ID reception.

At step 620, the RIS controller 601 may send a service query message (e.g. ServiceQuery ( ) to the base station manager 503 in order to obtain more information about network services or slice for which the RIS will be used. This information can be used to support multi-tenancy of RIS, various business models and the RIS resource allocation associated with the business model and ownership of RIS. The RIS controller 601 may act as an arbiter among the base stations, MNOs, or services using the RIS, for example when the RIS is shared in a time-multiplexed fashion.

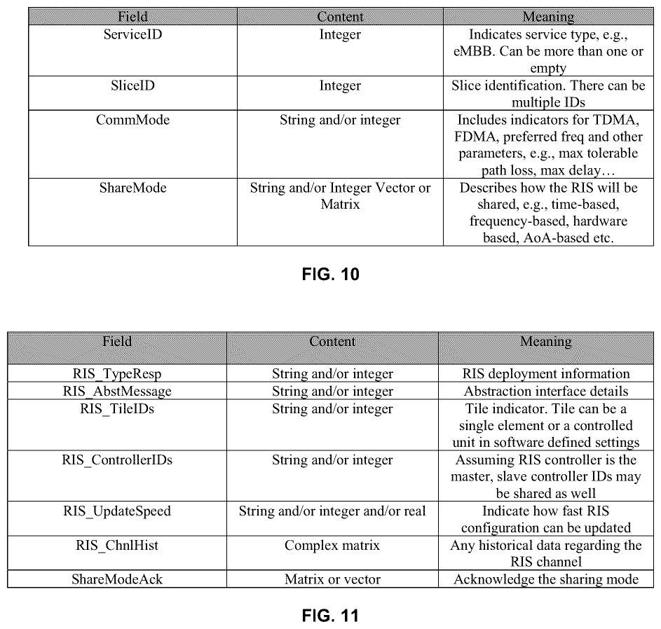

According to embodiments, the content and details of the service query message (e.g. ServiceQuery ( ), is provided in FIG. 10.

As illustrated above in FIG. 10, the service query message (e.g. ServiceQuery ( ) may include service ID (e.g. ServiceID). The service ID is used to query the service type (e.g. eMBB, URLLC). There can be none, one, or multiple service types that are desired to be associated with the RIS. The service type can also have multiple sub-categories (e.g. eMBB video, URLLC-ITS). This is useful particularly when the RISs are provided by different MNOs or RIS providers.

The service query message (e.g. ServiceQuery ( ) may also include slice ID (e.g. SliceID). The slice ID is used to query the slice(s) for which RIS will be used. There can be none, one or multiple slices for which the RIS service is requested. The RIS controller 601 may use the slice ID to allocate RIS resources and isolate different MNOs or services from each other. In some embodiments, such configuration may be performed by the CM 502 in the course of the RIS configuration. In some embodiments, RIS resource may be allocated by another CM or base station manager who belongs to another MNO. The RIS controller 601 may also communicate with the cloud that acts as a RIS manager and belongs to an infrastructure provider.

Further, the service query message (e.g. ServiceQuery ( ) may include a communication parameter (e.g. CommMode). The communication parameter (e.g. CommMode) may include the parameters indicative of communications preferred by the RIS controller. The communication parameter can also include parameters for multiple access type, communication frequency, maximum tolerable delay and other characteristics. If there exist some pre-configuration about the RIS controller(s), the communication parameter may include the name of the pre-configuration (e.g. RIS_T6 may indicate that RIS will communicate with TDMA at 6 GHz or similar settings).

In various embodiments, there exists an optional setting to indicate the sharing mode (e.g. ShareMode). The sharing mode may indicate how the RISs are shared. Most prominent sharing modes include time-shared, frequency-shared and infrastructure-shared.

In some embodiments, the RIS may be time-shared (e.g. TDMA). For example, in a certain time period (e.g. T_1), the RIS serves a certain network slice, service or MNO (e.g. slice_1, service_1, MNO_1). In another time period (e.g. T_2), the RIS serves a different network slice, service or MNO (e.g. slice_2, service_2, MNO_2). The length of each time period can be several scheduling intervals or longer.

In some embodiments, the RIS may be frequency-shared. In such case, different network slice, service or MNO served by the RIS utilizes orthogonal frequencies associated with the RIS. The frequency-shared RIS is beneficial particularly when the same area is to be served.

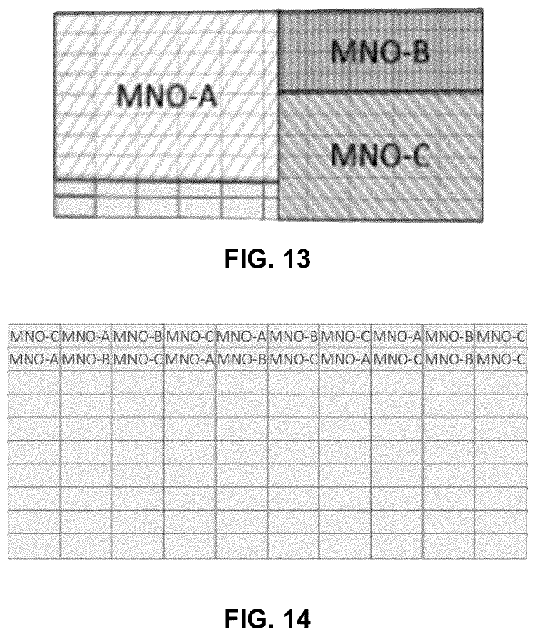

In some embodiments, the RIS may be infrastructure-shared. In such case, some reflective elements (tiles) of the RIS are allocated to certain network slice, service or MNOs. As such, the reflective elements allocated to certain network slice, service or MNOs do not occupy the entire surface of the RIS. Instead, the reflective elements of the RIS can be arranged in large blocks as illustrated in FIG. 13, or can be arranged in a distributed fashion as in FIG. 14. In the case of the reflective elements arrangement illustrated in FIG. 13, the beams from the base stations must be narrow such that only dedicated area is covered by the beams. In the case of the reflective elements arrangement illustrated in FIG. 14, the beam does not need to be narrow and directed. However, interference can occur and therefore base stations need additional support (or cooperation) to reduce interference.

In some embodiments, multiple sharing modes can be combined. For example, frequency and infrastructure based sharing modes can be combined.

Further referring to FIG. 9, the base station manager 503, at step 622, transmits to the RIS controller 601 a service query response message (e.g. ServiceQueryResp ( )) in response to the service query message (e.g. ServiceQuery ( )) received from the base station manager 503. In some embodiments, the service query response message may include IDs for the service and slice, and the setting for the communication mode.

According to embodiments, the content and details of the service query response message (e.g. ServiceQueryResp ( )), is provided in FIG. 11.

At step 624, communication is established between the RIS controller 601 and the base station manager 503. According to embodiments, additional parameters can be exchanged and further settings are done, until successful communication is established between the RIS controller 601 and the base station manager 503. In some embodiments, direct communications may be established between the CM 502 and RIS controller 601. In that case, the CM 502 may directly communicate with the RIS controller 601. In the case of wired communication, parameters and settings that are related to wireless communication may be ignored for communication control. However, the RIS still needs to be configured for communication with the base stations. Therefore, the relevant parameters may be exchanged to configure the RIS controller 601 to establish communications with the base station manager 503.

At step 626, the RIS controller 601 configures reflective elements (tile) of the RIS and determines the RIS information (information about the RIS) to share with the RIS service customer. In some embodiments, this may be performed by one or more other network entities depending on the business model and ownership of RIS.

In some embodiments, if the RIS deployment is essentially similar to a software-defined metasurface (or RIS-as-a-service) deployment, the RIS information to share may include ID of the RIS controller 601 as well as IDs of the reflective elements of the RIS. For In some other embodiments, while the IDs of the reflective elements are not shared, the available abstract settings or interfaces may be shared (e.g. steer, absorb, guide). The abstract messages may include one or more parameters such as angle of arrival, intended reflection direction, applicable wavelength, grid IDs and geographical location indicators.

At step 628, the RIS controller 601 sends a RIS information message (e.g. RIS_info) to the CM 502 either directly or indirectly through the base station manager 503. In some embodiments, instead of the RIS controller 601, an RIS manager sends the RIS information message to the CM 502.

According to embodiments, the RIS information message contains the shared RIS information that is determined in step 626. The shared RIS information may include, for example, RIS_TypeResp, RIS_UpdateSpeed, RIS_ChnlHist. RIS_TypeResp includes RIS deployment type information which may indicate or map to previously configured settings, for example available wavelengths or available wave manipulation methods (e.g. steer, absorb, guide). RIS_UpdateSpeed may indicate how fast the RIS configuration can be updated. RIS_UpdateSpeed may indicate the speed directly or map to pre-set values (e.g. through some parameters). RIS_ChnlHist includes any RIS channel sensing data that was previously shared with the RIS or sensed by any active elements in the RIS. This data may include some of the information about the cascaded channel.

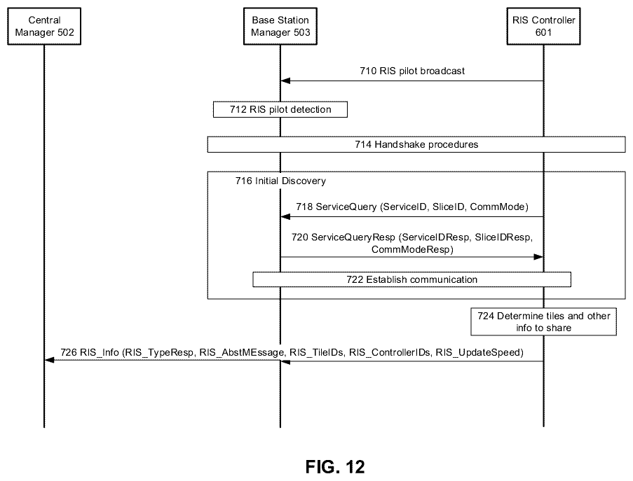

According to embodiments, there is an alternative RIS discovery process that may take place when the RIS deployment is not known to the CM (e.g. CM 502) or other relevant network entities (e.g. base station), as illustrated in FIG. 12. FIG. 12 illustrates an alternative RIS discovery process 700 when RIS is unknown to the base station, in accordance with embodiments of the present disclosure. The alternative RIS discovery process 700 is performed as the CM 502 does not have any priory information about the RIS deployment including its ID and IP address.

Referring to FIG. 12, at step 710, the RIS controller 601 broadcasts its pilot (i.e. RIS pilot). Then, the base station manager 503, at step 712, detects the RIS pilot signal. Upon the RIS pilot signal detection, the base station manager 503 and the RIS controller 601, at step 714, establish the communication there between through handshake procedures. Alternatively, the RIS controller 601 listens to the broadcast signals such as pilot signals from the base stations and communication is established with base stations similarly through handshake procedures. The handshake procedures are similar to the handshake procedures for the UE. A person skilled in the art would readily understand how the handshake procedures would be performed to establish the communication between the base station manager 503 and the RIS controller 601. Once the communication is established, RIS specific messages are exchanged, as illustrated in the rest of the procedure 700. The rest of the procedure 700, from step 716 to step 726, is substantially equivalent to the step 612 and steps 620 to 628.

According to embodiments, when the RIS discovery process 600 or the alternative RIS discovery process 700 is complete, channel sensing process (e.g. channel sensing process 518 in FIG. 5).

As illustrated above, there is provided a method for determining the RIS C&C sets in a centralized manner. The centralized RIS set determination method is flexible enough to support various cases including cases where many RIS deployment parameters are previously known and cases where no deployment parameter is known except IDs of some RIS that belong to the RIS deployments to be considered.

While the main entities in the processes illustrated in FIGS. 4, 5, 9 and 12, are the service manager, central manager, base station manager and RIS controller, it should be noted that the method and procedures (including the messages in the procedures) illustrated above and the related figures (e.g. FIGS. 4, 5, 9 and 12) are also applicable to other network entity sets. For example, a central manager and an RIS manager may message each other directly through the above procedures. It should be also noted that the method and procedures illustrated above allow settings for various RIS deployment types (from simple to complex RIS deployments) and support various business cases and RIS ownership scenarios.

According to embodiments, the RIS can be shared in various ways. Sharing of the RIS is supported in the discovery processes by exchanging information with the RIS controller. Most prominent RIS sharing modes include time-shared, frequency-shared and infrastructure-shared, which are illustrated above including details and technical benefits.

In all cases, time, frequency and tile related settings need to be completed.

### Grid-Based RIS Information Collection Method

According to embodiments, there is provided a method for collecting RIS information such that the central manager, base stations, RIS providers/managers or other relevant entities can facilitate RIS related analysis, particularly for determination of the RIS C&C set. The RIS information may be obtained in the form of a RIS capacity/coverage map. The RIS information collection method can be performed offline (e.g. during or before provisioning). The collected RIS information may be updated during run-time or upon change of the related network information. The RIS information collection method can be implemented in a centralized or distributed manner.

According to embodiments, the RIS information collection method is grid-based. As such, in this method, a geographical area is divided into smaller areas (i.e. grids) that are meaningful to describe characteristics of the network communication. The size of the grids may be fixed or varying based on the network communication characteristics. The network communication characteristics may include similar and different channel characteristics, current and expected network traffics, base station capacity, and access point density. These characteristics can be used as criteria to define grids.

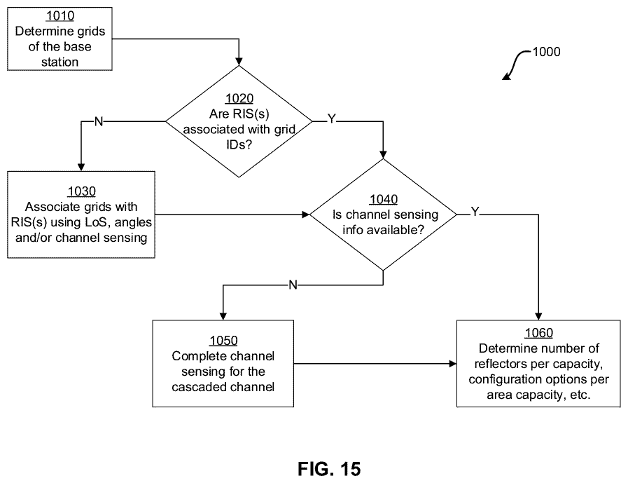

FIG. 15 illustrates an overview of the method 1000 for collecting RIS information, in accordance with embodiments of the present disclosure. Referring to FIG. 15, at step 1010, grids of the related base station(s) is determined, for example, a geographical area covered by the related base station is divided into grids. Upon determination of the grids, it will be determined, at step 1020, if RIS(s) is associated with any of the determined grids. IDs of the grids may be used for the determination.

If the RIS is not associated with any of the grids (e.g. not associated with any grid IDs), then the grids and the RIS(s) are, at step 1030, associated with each other, for example using one or more of LoS (e.g. visual LoS, wave LoS), angles for reflective elements of RIS (e.g. arrival angle, intended direction of reflection) and channel sensing. On the other hand, if the RIS is associated with one or more grids, then step 1030 will be skipped.

Once the RIS(s) and the grids are associated, at step 1040, it is determined whether channel sensing information is available. If not available, the base station manager, at step 1050, performs the channel sensing process (e.g. step 518 in FIG. 5) for cascaded channel. On the other hand, if the channel sensing information is available, then step 1050 will be skipped.

Once the channel sensing information is available, at step 1060, information needed for grid-based analysis is determined. For example, the number of reflective elements (e.g. tiles, reflectors) of the RIS per capacity, and configuration options per area are determined.

According to embodiments, the RIS information collection method support grid-based analysis such that the central manager, base stations, RIs providers/managers or other relevant entities can effectively capture characteristics of RIS deployments, including reconfigurable reflective elements.

As stated above, the grid-based RIS information collection method be performed offline (e.g. during or before provisioning). This allows complex computations that require a long calculation time and large computation power. Therefore, an exhaustive search can be conducted to obtain the communication capacity of each grid for all possible configurations of the RIS elements.

According to embodiments, the RIS C&C set can be determined based on capacity of grids. The grid capacity can be determined based on the single RIS deployment's capacity only or all possible configurations of multiple RIS deployments. When the grid capacity is based on all possible configurations of multiple RIS deployments, the search space rapidly expands as all possible combinations of multiple RISs are jointly considered. This approach (based on all possible configurations of multiple RIS deployments) is beneficial especially when the grids can be jointly served by multiple RISs. Therefore, it is more effective to only consider combinations of RIS reflective elements that can serve grids mutually with other RIS reflective elements. As not all of possible combinations of all RIS elements need to be considered, such consideration would reduce the search space and dimensionality of the problem.

Whether it is based on the single RIS deployment's capacity only or all possible configurations of multiple RIS deployments, the grid capacity mostly depends on the communication between the RIS and terminal device (e.g. RIS-UE side of the cascaded channel). However, it is also possible to include the other side of the channel (e.g. RIS-BS side of the cascaded channel). If the base stations have multiple-input-multiple-output (MIMO), different configurations for joint active and passive beamforming can be evaluated for each grid. Furthermore, if another base station, apart from those associated with the RIS, is serving the grid, its effect can also be considered. This may also require accounting for different beamforming configurations of the other base stations.

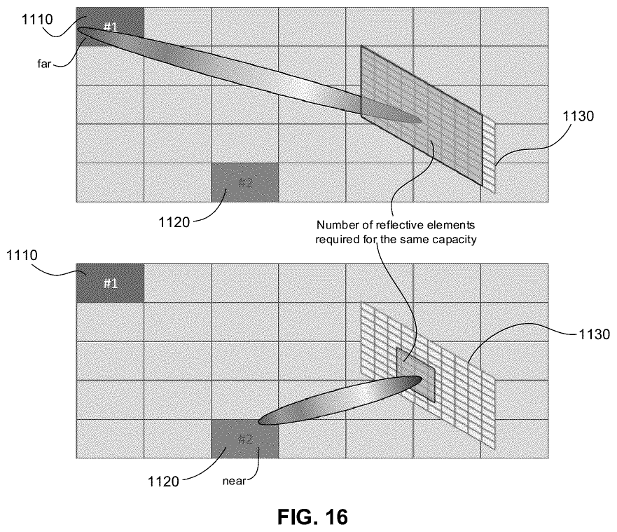

In the grid-based analysis, the number of RIS reflective elements per capacity can be considered. In other words, in order to obtain ‘X’ amount of capacity at grid ‘Y’, ‘Z’ amount of RIS reflective elements need to be configured and used to serve the grid ‘Y’. This provides a better idea about the cost of services on a particular grid. For instance, FIG. 16 illustrates the number of the RIS reflective elements required to provide a certain amount of capacity at two different grids, in accordance with embodiments of the present disclosure. As illustrated in FIG. 16, the number of the RIS reflective elements required to provide a certain amount of capacity (e.g. peak data rate, spectral efficiency, spectral energy or any combination thereof) can vary depending on the location of the grid. Specifically, referring to FIG. 16, more resources are required to provide the same capacity to grid 1110, as the grid 1110 is further apart from the location of the RIS 1130 than the grid 1120. The grid-based analysis may also include the rest of the cascaded channel. Then, it can be described as the number of RIS reflective elements needed per capacity per configuration type.

As a practical tool, visual line of sight (LoS), wave LoS or both may be utilized to determine the grids associated with reflective elements of the RIS (e.g. which grids can be seen by reflective elements of the RIS) and the cooperation combination of base stations and reflective elements of the RIS (e.g. which base stations can cooperate with which reflectors (if not all)), thereby narrowing the search space. Any differences between visual LOS and wave LoS must be taken into account to ensure that no relevant RIS elements (e.g. reflectors) are missed or no irrelevant RIS elements added in the allowable set. For this, various maps, such as city maps or three dimensional maps, may be used.

Similarly, various analytical calculations (e.g. angle-based calculations) may be utilized to determine service combination of grids and reflective elements of the RIS (e.g. which grids can be served with which reflective elements of the RIS). For example, angles for the reflective elements of the RIS (e.g. arrival angle, intended direction of reflection) can be utilized to determine service combination of grids and reflective elements of the RIS.

If association between grids and RISs and association between terminal devices (e.g. UEs) and RISs in the cascaded channel are already estimated and analyzed by one of the base stations, the analyzed information can be re-used by that base station and can be even shared with other base stations. This prevents resource waste as no same analysis, channel sensing or analytical calculation will be conducted by the same or different base stations. The analyzed RIS information can be distributed among base stations via messaging between them or can be broadcasted by a CM or another entity in the core network, upon request.

If the RIS includes active elements, the channel sensing data can be also obtained from those elements.

In some embodiments, the grid capacity can be computed in consideration of a multi-hop RIS deployment. For example, for frequencies greater than 6 GHZ, multiple RISs may be used to relay the signal of a base station to a grid.

Therefore, in various embodiments, traffic estimations, service requirements, capacity of base station(s) at each grid, active beamforming combined with passive beamforming, whether the RIS information is shared can be used as parameters or criteria for grid-based analysis.

According to embodiments, output of the grid-based RIS information collection method can be used by various entities such as base stations, a CM, a RIS controller or an RIS provider/manager. The output of the grid-based RIS information collection method may be shared fully or partially, depending on the exposure level and service level agreements between the RIS provider and RIS consumer.

The grid-based RIS information collection method can be implemented by base stations, a CM, or an RIS provider/manager, in a centralized or distributed manner.

When implemented in the centralized manner, a central network entity (e.g. CM) collects all the information and is also responsible for analysis. The central network entity may use its central AI engine(s) for analysis.

When implemented in the distributed manner, grid-based analysis can be conducted in a distributed manner in several ways.

In some embodiments where grid-based analysis is conducted in a distributed manner, each local entity (e.g. base station) is responsible for a geographical area, and determines its grids on its own. The local entity may also be full responsible for RIS channel sensing and grid-capacity calculations, including the exhaustive search option.

For RIS channel sensing, some channel sensing information can be alternatively obtained from neighboring base stations.

For grid-capacity calculations, some analysis results such as traffic estimations or grid-based analysis results for RIS can be alternatively obtained from neighboring base stations. The grid-based analysis results for RIS may be obtained in a similar manner to transfer learning. The results of these analyses can be also obtained from a central network entity (e.g. CM). In such cases, the base station may request for required analysis, for example with geographical area information and requested analysis type (e.g. traffic estimation or RIS capacity per reflective element). This information alternatively can be pre-sent to the base stations that will conduct grid-based analyses.

In some embodiments, if the base station is a central unit (CU), some grid-based analysis may be conducted with help of distributed units (DUs). In some embodiments, the grid-based analysis may be conducted as a group, for example in the case of federated learning. The learning clusters may be self-obtained. In other words, the units that will make analysis for a certain area exchange messages to join or reject joining a learning group. For instance, a base station may reject joining the federated learning cluster because it does not have sufficient computation power available at the time of conducting the grid-based analysis.

In some embodiments, the learning groups can be determined by a central network entity (e.g. CM, AMF or another core network function) based on locations, available computation power and other relevant factors. This can be considered as a semi-distributed method.

In some other embodiments where grid-based analysis is conducted in another distributed manner, a central network entity (e.g. CM) determines the grids, for example via historical analysis, and assigns the grids to base stations. The central network entity may assign the grids to the base stations based on location, signal strength or other relevant factors.

The learning or grid-based analysis can be conducted in several ways. In some embodiments, once the grids are assigned by the central network entity, one or more of the distributed nature methods and self-organizing methods illustrated above are utilized. In some other embodiments, the central network entity (e.g. CM) further assigns the learning tasks and organizes the sharing of available previous analysis (e.g. transfer learning, sharing previously collected data). If federated learning or other similar method is used, the central network entity may determine the federated learning groups and distribute tasks. The federated learning groups can be determined in consideration of one or more objectives, for example to minimize computation time, or to evenly distribute computation load. If transfer learning or similar method is used, part of the grid-based analysis may be conducted centrally or conducted initially at the most computationally powerful base stations. The analysis result(s) may be shared with other base stations to facilitate their jobs. If there is a hierarchical AI architecture (e.g. CM AI, several RAN AIs and base station AIs), several data collection and analysis tasks can be distributed using AI engines. The AI engines may utilize specific messages for grid-based analysis requiring RISs.

In embodiments where grid-based analysis is conducted in a distributed manner, examples of RIS information (data) and analysis that can be shared for distributed learning are provided below. It is noted that sharing of the RIS data may be applicable to centralized learning.

The RIS information and analysis that can be shared includes RIS deployment information, for example number and properties of RIS reflective elements that are available for the requested service, slice, operator or geographical area. The RIS deployment information may further include RIS abstraction (e.g. modes, messages). The RIS deployment information may also contain how often and how fast the RIS elements can be configured, the IDs of passive and active elements (if there is any) and any other information that can be utilized to estimate performance of the RIS and facilitate control and configuration of the RIS.

The RIS information and analysis that can be shared also includes the number of RIS reflective elements (e.g. reflectors) for a certain amount of capacity per grid analysis. The number of RIS reflective elements may be changed depending on the grid. It corresponds to different configurations of the RIS. Alternatively, the number of RIS reflective elements for a certain amount of capacity per a geographical area may be considered. The capacity can be measured in terms of peak data rate, spectral efficiency, spectral energy or any combination thereof. A catalogue may be generated including various capacity levels for each geographical area.

If RIS is obtained as a service from an RIS provider, some RIS information may be abstracted using grid-based analysis.

Grid IDs may be associated with RIS IDs, RIS element IDs or both. For instance, the grid IDs that associated with an RIS ID indicate that the grids can be served by the RIS to provide a certain amount of capacity. It is understood that not all of the grids may be provided with the same capacity at the same time.

According to embodiments, the messaging for grid-based method includes the items described for the method, e.g. LoS information, 3D map information, any ray-tracing experiments or simulations that may have taken place offline, historical data thereof.

According to embodiments, the output of the grid-based method can be used to determine RIS C&C set, RIS-as-a-service slice, RIS C&C slice or pre-configured RIS deployments, thereby enhancing run-time operations and updating run-time configurations of RIS. In some embodiments, the grid-based analysis can be obtained by AI based algorithms and utilizing specific AI engines (e.g. management AI function). In some embodiments, the grid-based data can be anonymized and shared on a cloud.

According to embodiments, configuration for multi-hop cascaded channels can be conducted based on various factors including a limited number of hops, a limited geographical area containing the nodes the effects grid capacity, a limited set of nodes that effects the grid capacity, a limited set of base stations that use the RISs, service requirements, and mutual grids that can be served by multiple RISs, or any combination thereof. The size of the base station set or geographical area (e.g. grid or a set of grids) can depend on one or more factors, such as service type, user mobility and required minimum capacity.

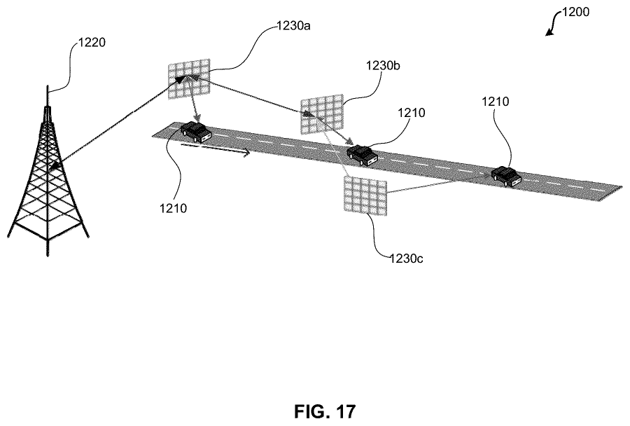

FIG. 17 illustrates an example of multi-hop RIS communication system 1200, in accordance with embodiments of the present disclosure. The multi-hop RIS communication is utilized in a high mobility scenario in order to reduce handover from one base station to another base station. As illustrated in FIG. 17, the vehicle 1210 is moving from left to right direction (as indicated by an arrow). Initially, the vehicle 1210 communicates with the base station 1220 only via the RIS 1230a. As the vehicle 1210 moves, it becomes away from the RIS 1230a and closer to the RIS 1230b. Due to the distance between the vehicle 1210 and the RIS 1230a, the vehicle 1210 cannot effectively communicate with the base station 1220 via the RIS 1230a. As such, the vehicle 1210 needs to communicate with the base station 1220 via the RIS 1230a and the RIS 1230b. When the vehicle 1210 moves further, it becomes away from the RIS 1230b and even further away from the RIS 1230a. Due to the distance between the vehicle 1210 and the RIS 1230b, the vehicle 1210 cannot effectively communicate with the base station 1220 via the RIS 1230a and the RIS 1230b. As there is another RIS 1230c closer to the vehicle 1210, the vehicle 1210 now needs to communicate with the base station 1220 via the RIS 1230a, the RIS 1230b and the RIS 1230c (i.e. multiple hops). In this multi-hop RIS communication case, mobility and route of vehicles may be considered to determine the set of nodes and geographical area that will be considered to evaluate the grid capacity.

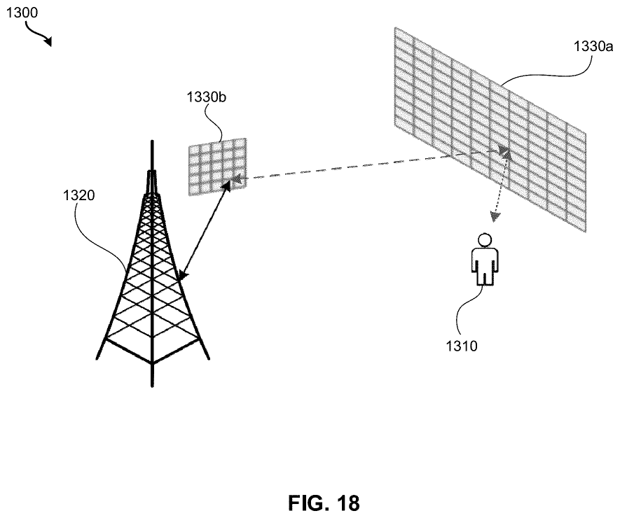

FIG. 18 illustrates another example of multi-hop RIS communication system 1300, in accordance with embodiments of the present disclosure. In this case, the multi-hop RIS communication is utilized where one RIS is close to the source and another RIS is closed to the destination. Provided that having an RIS deployment close to the source or destination provides the best results, multi-hop systems such as the multi-hop RIS communication system 1300 can increase the efficiency of communications. In the case of the multi-hop RIS communication system 1300, multi-hop elements effecting grid capacity can be chosen among the ones close to the destination (e.g. RIS 1330a close to the UE 1310) or the source (e.g. RIS 1330b close to the base station 1320). Assuming downlink, locations of the UE 1310 can be estimated based on mobility analysis, historical analysis or current data regarding the UE positions.

Loads of neighboring base stations to determine interference can be another factor to consider when determining the grid capacity. The loads of neighboring base stations can depend on historical analysis, historical data collected from UEs and BSs, and so on. Alternatively, interference may be omitted in calculations.

As illustrated above, there is provided a method to obtain and abstract the RIS information from the point of communication service provider. By considering the association of geographical areas (e.g. grid or a set of grids) with RISs and their elements, the provisioning, pre-configuration and run-time of RIS C&C can be enhanced significantly.

Without knowing which geographical areas or grids can be associated with the RIS or RIS elements, it can be difficult for the base stations to decide whether or not to use an RIS for a particular user (because all the users cannot see the RIS). The RIS controller can obtain the area maps where the area is divided into grids. Knowing the details of the surrounding area using the maps and the RIS deployed position and associated directions, the RIS controller can estimate the grids that can be served by a given RIS. This information can be sent to the base station that is performing C&C with the required angles to cover each grid. It should be noted the conventional user access methods cannot be used as the users cannot see the base station pilot. Also, when a user randomly transmits without specific phase shift, RIS cannot direct it to the base station. If the user already has a connection to the base station, the base station can calculate the angles, calculate the phase shifts and have a handshake with the RIS. Therefore, with grid-based system, base stations can pre-configure the angles, and send a signal via the RIS to adjust the phase shift so that the UE can receive the pilot. There may be an initial mode for the RISs such that the base station tries to scan the area via RIS phase shift changes. The base station repeats the scan so that the UEs can receive the pilots at different times and establish the handshake. The grid-based method can address this initial phase.

### Distributed RIS C&C Set Determination

According to embodiments, there is provided a method for determining RIS C&C set in a distributed manner. In various embodiments, the base stations cooperate with each other, central network entities (e.g. CM, AMF), network managers, or combination thereof for determining of the RIS C&C set collaboratively. In the distributed RIS C&C Set determination method, there is little or no intervention from the central network entities (e.g. CM or core network functions). The method is substantially similar to the concept of self-organizing network and the learning takes place in a mostly distributed manner as well.

According to embodiments, the distributed RIS C&C set determination method provides two distributed mechanisms, fully distributed mechanism and partially distributed mechanism.

In the case of fully distributed mechanism, a set of base stations cooperate to provide C&C of the RIS deployments. For this, the base stations exchange information on a regular basis and may join the RIS C&C set or leave the RIS C&C set. The base stations exchange information on a regular basis and may join the RIS C&C set or leave the RIS C&C set. The information exchanged between base stations may include their current network traffic load, computation load, historical load analysis of traffic and computation, channel between base stations and RIS, available bandwidth for RIS control, available processing power for RIS configuration, available crowd sourcing methods (i.e. options for crowd sourcing), various available learning methods (i.e. options for learning method) (e.g. federated learning, transfer learning, swarm learning, split learning).

In the case of partially distributed mechanism, base stations collaborate with core network (CN) or network management (NM) functions. As stated above, the base stations exchange information on a regular basis and may join the RIS C&C set or leave the RIS C&C set. For this purpose, an RIS C&C selection function may be implemented in the core network (CN) or network management (NM) functions, which leads to semi-distributed or centralized methods. Therefore, in the partially distributed mechanism, base stations also collaborate with the RIS C&C function.

According to embodiments, the distributed method, especially fully distributed method, requires increased communications between nodes, as illustrated below and elsewhere in the present disclosure. It should be noted that the base stations in this case can also be non-terrestrial network components as well as heterogeneous terrestrial nodes (e.g. UEs, internet-of-things (IoT) devices, etc.).

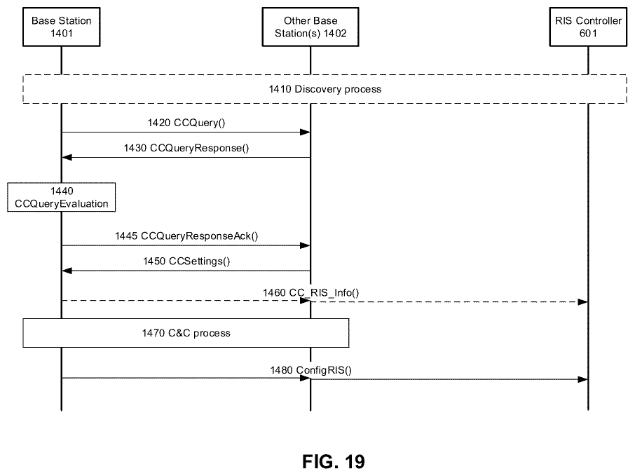

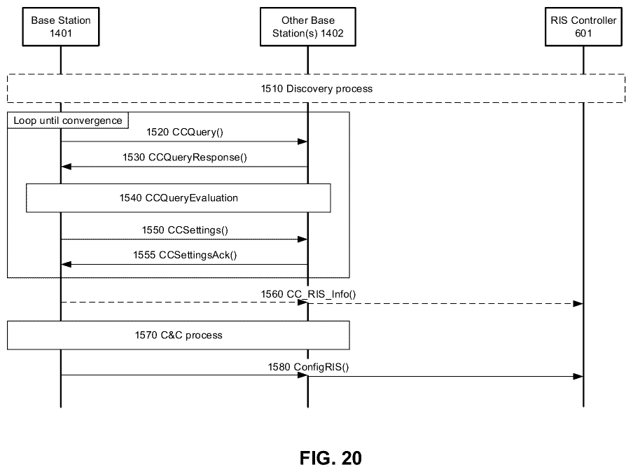

FIGS. 19 and 20 illustrate distributed C&C, in accordance with embodiments of the present disclosure. Specifically, FIG. 19 illustrates distributed C&C with a base station or a set of base stations organizing the C&C process. FIG. 20 illustrates distributed C&C without any pre-configurations or a set of base stations organizing the C&C process.

Referring to FIGS. 19 and 20, the base station 1401 may or may not be aware of the RIS(s). If the base station 1401 is not aware of RISs, an initial RIS discovery take place at step 1410 and step 1510. The initial discovery processes steps 1410 and 1510 are substantially equivalent to the initial discovery process described above and in FIGS. 9 and 12 (i.e. steps 612 to 624 and 716 to 722).

As illustrated below, the initial discovery process does not need to be triggered by CM (e.g. RISTest ( ) message transmitted by the CM). The initial discovery process can start by any other triggers related to communication services, network requirements, performance management or combinations thereof.

In some embodiments, a central network entity (e.g. CM, AMF) may trigger the initial discovery process. In this case, the base station(s) 1401 has the RIS information at least including IDs and locations of RISs. The base station(s) 1401 may have further RIS information, such as one or more of RIS deployment type, reflective element IDs, active RIS element IDs, and master/slave controller IDs, abstraction levels, available modes and other properties of an RIS deployment. In some embodiments, RIS deployment type may be a part of the RIS ID. When a central network entity (e.g. CM, AMF) triggers the initial discovery process, the central network entity only initiates the distributed RIS C&C set determination. The initiation may be triggered by some performance management factors, for example a need for utilizing RIS capacity, a new RIS deployment, and a new service to be provided in the area covered by the RIS.

In some embodiments, the initial discovery process may be self-triggered based upon an anticipated traffic increase, performance degradation and other relevant factors. In this case, the RIS may already have the information of available nearby RIS deployments. Alternatively, the base station 1401 may broadcast a generic discovery signal that can be caught by RIS controllers 601. Available RIS controllers 601 respond back to the base station 1401 with RIS information, such as one or more of RIS deployment type, reflective element IDs, active RIS element IDs, and master/slave controller IDs, abstraction levels, available modes and other properties of an RIS deployment.

In some embodiments, the initial discovery process may be triggered by a message from the RIS controller 601 (e.g. a handshake message, pilot message). The RIS controller 601 may transmit this message when a new RIS is deployed. In this case, the RIS ID may be not the one previously known to the base station 1401. The RIS ID and other RIS information can be included in the first message transmitted by the RIS controller 601. Alternatively, the RIS controller 601 can send the RIS ID and other RIS information after it receives an acknowledgement message from the base station 1401.

When the base station 1401 gets triggered, the base station 1401 may not (try to) discover the RIS deployments. Instead, the base station 1401 may query other base station 1402 or CN functions (e.g. AMF) to obtain RIS (deployment) information. This is one of the key differences between the discovery process in the distributed RIS C&C determination method and the discovery process in the centralized RIS C&C determination method.

In some embodiments, the RIS discovery may be performed periodically using one or more ways illustrated above. For this, the base station 1401 or RIS(s) broadcasts pilot signals periodically.

Upon the initial discovery process, the base station 1401 may collaborate with other base stations 1402 to establish a RIS C&C set. As illustrated in FIGS. 19 and 20, the base stations exchange a set of messages to determine each other's suitability to be in the RIS C&C set.

In some embodiments where one (set of) base station(s) 1401 is organizing the RIS C&C set determination, the base station 1401, at step 1420 as illustrated in FIG. 19, sends an initial C&C query request to other base stations 1402. The initial C&C query request may include one or more of: IDs of RISs and base stations, IDs of RIS reflective elements, IDs of RIS controllers, RIS deployment types, RIS locations, RIS capacities and other properties of RIS deployments to be controlled and configured.

In some other embodiments where no base stations are responsible for organizing the RIS C&C set determination, the base stations 1401 and 1402 may collaboratively determine the RIS C&C set, as illustrated in FIG. 20. This requires the base stations 1401 and 1402, at step 1520, send queries and responses to each other. If the base station that receives the query has not completed the discovery phase, it may utilize the RIS ID and/or location information to determine a set of RISs for which it can be responsible.

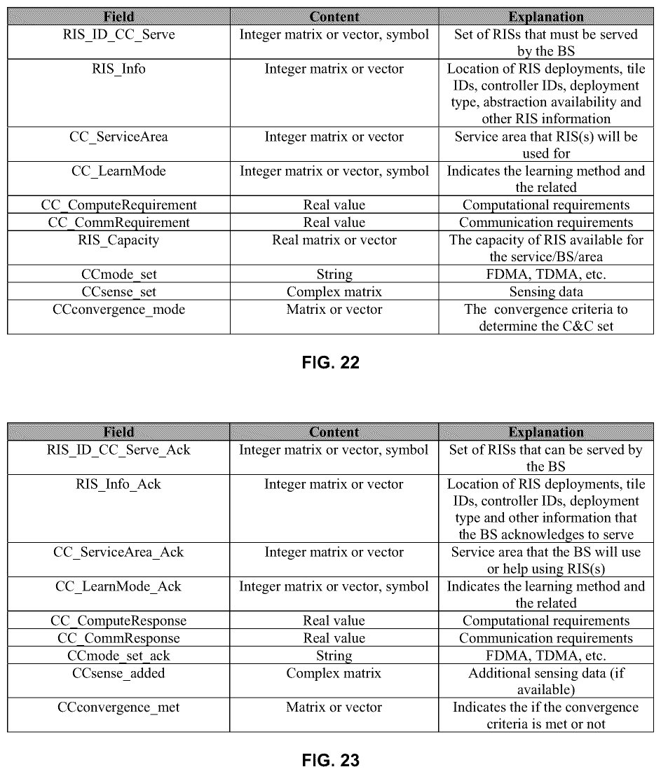

According to embodiments, the content and details of the initial C&C query request message (e.g. CCQuery ( ), is provided in FIG. 22.

As illustrated above in FIG. 22, the initial C&C query request message (e.g. CCQuery ( ) may include various fields for a set of RISs that must be served by base stations (e.g. base stations 1401 and 1402), basic RIS information (e.g. RIS_Info), capacity of RIS (e.g. RIS_Capacity), learning method (e.g. CC_LearnMode), computational requirements (e.g. CC_ComputeRequirement), communication requirements (e.g. CC_CommRequirement) and convergence criteria to determine the C&C set (e.g. CCconvergence_mode). In various embodiments, at least some content of the initial C&C query request message (e.g. CCQuery ( ) are forwarded to distributed units by a central unit.

Referring to FIG. 22, RIS_Info may include several integer codes to represent RIS deployment type, availability of abstraction and active elements. Capacity of RIS (RIS_Capacity) may be demonstrated in terms of number of reflective elements, or grid-based capacity, if such analysis is available. If RIS capacity is demonstrated in terms of number of reflective elements and/or passive elements to be configured, it can help the base station to estimate the required computation power and to determine whether the RIS service will be adequate and useful for the services provided by the base station.

CC_LearnMode field is used to indicate the learning mode that will be used to derive RIS configuration and, if applicable, to analyze RIS sensing information. The learning mode can be any distributed learning mode (e.g. transfer learning, federated learning, swarm learning). In case of federated learning, the base stations may be grouped into sets.

Based on the learning type, the CC_LearnMode field can include further specific details, such as size of the learning set for federated learning, IDs of the base stations that will share models for transfer learning, and the frequency of computations. If one of the base stations is operating like a central network entity that organizes the distributed learning, for example in case of federated learning, the ID of such base station may also be included.

CC_ComputeRequirement field includes information indicative of the amount of computational power required to derive configuration parameters of the RIS. There are several ways to represent and estimate the computational power requirements.

In some embodiments, CC_ComputeRequirement field may indicate the power required to complete the analysis. The base station that receives the initial C&C query request message (e.g. CCQuery ( ) may respond with the available resource amount (or percentage) that it could provide. In some embodiments, the computational power can be demonstrated in terms of the number of required CPUs/GPUs, required time length to complete a certain computation.

Alternatively, the CC_ComputeRequirement field may include information about the problem to be solved (e.g. dimensionality, size of matrices to be calculated, number of elements) and the base station that receives the initial C&C query request message can estimate itself whether it has sufficient capacity or not.

The CC_ComputeRequirement field may contain the amount requested specifically from that BS. The BS may reject the request, or respond with a suitable amount that it could provide (may be lower or higher than the requested amount).

The computational power requirement indicated in the CC_ComputeRequirement field may be significantly lower or higher than the power required in actual computation. As such, at least one of the base stations may learn the power required during the computation in terms of a few parameters. Some example of the parameters include the area to be served, the number of active and passive elements to be configured, number of hops in the cascaded channel, number of grids and other grid based analysis (e.g. traffic density), type of RIS deployment (e.g. more complex deployments with abstraction may require less computation). The base stations may learn in a distributed way. This helps each base station more precisely evaluates whether it can meet the computational requirements or not.

The CC_CommRequirement field indicates the communication requirements. The communication requirements can be demonstrated, for example in terms of bandwidth, frequency blocks, bits per second (bps), duration, maximum latency or any combination thereof. The bandwidth is required for both configuration-related communications and the communication with the RIS controller/manager. The configuration-related communication may include communication among base stations and communication with centralized servers, cloud servers or users (e.g. for crowdsourcing). The communication with the RIS controller/manager is utilized to configure the RIS deployments. The communication requirements can be indicated separately or in total.

It is noted that the communication with users, RIS nodes and other network entities may require different types of resources. For example, links between user and base station(s) can be wireless and links between base stations may be wired links employing the Xn interface. It is further noted that a base station may be responsible for either communication or configuration, but not for both communication and configuration.

The CCconvergence_mode field is used when there is no pre-configured or arranged set of base stations that organize the C&C. Put another way, the CCconvergence_mode field may be only used for the process illustrated in FIG. 20. The CCconvergence_mode field is used for setting up a convergence criteria to meet C&C requirements. In various embodiments, the convergence criteria may be that the C&C requirements will be 95% covered (e.g., 95% of the time). The convergence criteria may not be met until all the resources are allocated or reserved for computing and communications. Each base station may have a collection of queries and corresponding responses, and evaluate whether the convergence criteria is met or not.

Referring back to FIGS. 19 and 20, in response to the initial C&C query request, the base stations collect the C&C query response at steps 1430 and 1530.

In some embodiments where one (set of) base station(s) 1401 is responsible for sending (transmitting) the C&C queries and collecting (receiving) the C&C query responses, the base station 1401, at step 1430 as illustrated in FIG. 19, collects the C&C query responses. Upon collecting the C&C query responses successfully, the base station 1401, at step 1445, sends an acknowledgement message (e.g. CCQueryResponseAck ( ) to the base station(s) 1402 that sent the query response(s).

The base station 1401 also determines the C&C tasks and communicates them with other base stations. The base stations from the RIS C&C subset can be also responsible for C&C. This method is beneficial in that there are fewer messages (i.e. reduces the message exchange). However, as stated above, pre-configuration may be required and scalability can be an issue (e.g. number of base stations can be limited).

In some other embodiments where no base stations are responsible for organizing the RIS C&C set determination, the base stations 1401 and 1402 may collectively determine the RIS C&C set by updating query responses and broadcasting them to other base stations until a convergence criteria is met (i.e. loop until convergence). For example, if 95% of the initial query requirements are completed, the settings of the base stations at the time can be set as their C&C responsibility, as shown in FIG. 20. In this case, the query response message is sent to all the base stations 1401 and 1402 that are in the query set, and several query responses can also be received by other base stations 1401 and 1402. This method can be implemented using block chain based method and therefore the communication between base stations can be secure. This method can be also implemented using distributed learning base methods. For example, base stations act as agents and share models to comply transfer learning. Also, this method is completely dynamic and scalable, and does not require pre-configuration. However, there will be more message exchanges, in particular in comparison to the other method illustrated above and in FIG. 19.

The C&C query response includes a set of RISs that can be served by other base stations 1401 and 1402. As such, the C&C query response may include none, some or all of the RISs, areas and RIS portions requested in the initial C&C query request. For instance, the base stations may be able to configure RIS to use it or to help it being used for a smaller area than the originally requested area.

According to embodiments, the content and details of the C&C query response message (e.g. CCQueryResponse ( ), is provided in FIG. 23.

As illustrated above in FIG. 23, the C&C query response message various fields including CC_LearnMode_Ack, CC_ComputeResponse, CC_CommResponse and CCconvergence_met.

CC_LearnMode_Ack field indicates whether the learning mode is supported by the base station. Some learning mode may not be supported for example due to privacy issues, computation requirements and communication requirements. If another learning mode is available, CC_LearnMode_Ack may indicate that learning mode is available. If all learning modes are not available, CC_LearnMode_Ack may indicate that all learning modes are rejected. It should be noted that rejection to participate in distributed learning (e.g. computing for configuration) does not mean the base station is also released from communication responsibilities.

CC_ComputeResponse and CC_CommResponse fields include the responses to the communication and computation capacity requests. The base station may accept the requirements, reject them completely, or propose other values depending on the available capacity in terms of computation and communication. The base stations may send additional sensing data, if it is available and not already contained in the previously collected sensing data.

CCconvergence_met field indicates whether the convergence criteria are met or not. This field can demonstrate whether base stations meet the requirements or fail to meet the requirements. When the base stations may exchange queries and responses with different sets of base stations, this field helps to reach a unified solution.

Referring back to FIGS. 19 and 20, C&C query evaluation takes place at steps 1440 and 1540. In some embodiments, as illustrated in FIG. 19, one or a subset of the base stations 1401 may be responsible for C&C set determination. This may be pre-configured by a central network entity (e.g. NM, NSMF, NSSMF, RAN manager, CN function). A base station 1401 may be chosen to determine the C&C set based on its proximity to the RIS, the channel quality between RIS and the base station 1401, and the computational power. Alternatively, the selection may be automatically performed by the base stations 1401, for example depending on the load of base stations 1401 via exchanges of messages. In a hybrid alternative, a pre-configured set of base stations 1401 may be updated by the base stations 1401 automatically, if the previously chosen base stations become overloaded with other tasks.

In some other embodiments as illustrated in FIG. 20, the base stations 1401 and 1402 may share and evaluate the C&C query responses until some convergence criteria is obtained, for example until the computation and communication requirements are satisfied with a 95% probability (e.g. 95% of the time).

During the process, the C&C query request (e.g. CCQuery ( )) and C&C query response (e.g. CCQueryResponse ( )) messages may be exchanged several times for different criteria. CCconvergence_met field in the C&C query response indicates whether the convergence criteria are met or not. Each base station may exchange query and response messages with other base stations. This helps with scaling and reducing the load of control messaging. The CCconvergence_met field helps to unify the results. Base station IDs or IP addresses can be used to determine which nodes can or cannot satisfy the convergence. It should be noted that convergence criteria may be updated if base stations fail to obtain a feasible solution. There can be different convergence criteria for different requirements.

Once the C&C query evaluation is completed, C&C settings are finalized for each base station in the RIS C&C set at steps 1450 and 1550. The C&C settings may be automatically set by each base station while sending the C&C query response message (e.g. CCQueryResponse ( )) at steps 1430 and 1530.

Alternatively, one or more base stations 1401 responsible for organizing RIS C&C may send C&C settings. This C&C setting contains parameters that are potentially different parameters from those in the C&C query request and response messages. However, each of the parameters remains within the acceptable limits specified the C&C query response message. The base station(s) that distribute the C&C settings may receive acknowledgement messages (e.g. CCSettingsAck ( )) from those that receive the C&C setting, as specified at step 1555 in FIG. 20. The acknowledgement message may contain the convergence acknowledgement. The base stations that distribute the C&C settings may also collaborate to obtain a feasible set of C&C settings and converge to a resource/responsibility assignment solution.

Then, the base station 1401, at steps 1460 and 1560, sends an RIS information message (e.g. CC_RIS_Info ( )) the RIS controller 601to indicate how often, when, by which base station(s), for which RIS reflective element(s) and for which services the RIS configurations will take place.

At steps 1470 and 1570, the base stations 1401 and 1402 perform RIS C&C process. In the end of the process, resources are allocated or reserved to compute the RIS configurations (e.g. beamforming matrices) and communications for RIS programming.

At steps 1480 and 1580, the base station(s) 1401 or 1402 sends a message for RIS configuration (e.g. ConfigRIS ( )) to the RIS controller/manager 601. The set of selected base stations 1401 or 1402 may send the RIS configuration message directly to the RIS controller/manager 601 or indirectly to the RIS controller/manager 601 using a multi-hop channel, for example those containing other RISs to relay the message. If the configuration computation is not conducted at the base station 1401 or 1402 that communicates with the RIS, the base station 1401 or 1402 receives the configurations before communicating with the RIS controller/manager 601.

In the distributed method of the RIS C&C set determination, the centralized entity is either not involved or has minimal intervention (e.g. to pre-configure some elements). The distributed method of the RIS C&C set determination is an alternative to the centralized RIS C&C set determination method and provides scalability and data privacy. Scalability is provided as base stations may organize with different subsets in the distributed method, whereas in the centralized method one central network entity tries to collect data from a large number of base stations. The data privacy is obtained as each base station makes its own analysis and only shares certain information such as the evaluation results or AI model. This means that whole raw data exchange does not need to occur, thereby rendering enhanced data privacy.

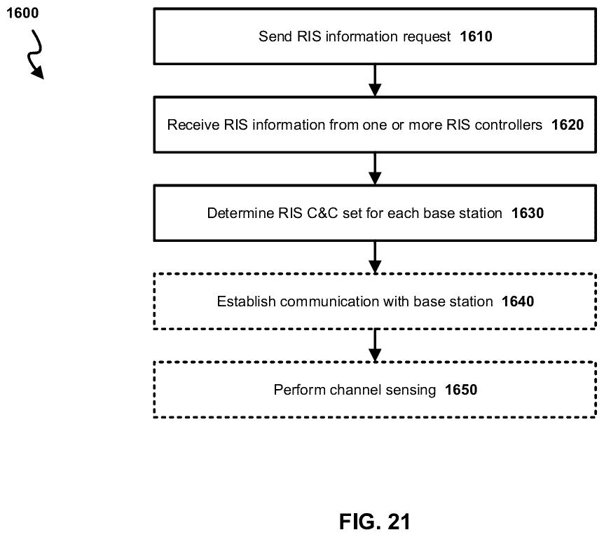

FIG. 21 illustrates a method for configuring reconfigurable intelligent surfaces (RISs) to support network service, in accordance with embodiments of the present disclosure. The method includes sending 1610 a RIS information request for RIS information at least in part defining a capability of one or more base stations for provision of control and communication (C&C) of the RIS deployments, the RIS information request including information indicative of a set of RISs requiring C&C. The method further includes receiving 1620, from one or more RIS controllers, RIS information, the received RIS information including information indicative of one or more configurable RISs for which each base station is capable of performing C&C. The method further includes determining 1630 a RIS C&C set based on one or more of: (a) one or more characteristics of each base station, and (b) the one or more characteristics at least in part determined from the RIS information, the RIS C&C set including one or more base stations responsible for C&C of the RIS deployments.

In some embodiments, when communication between a particular base station and an associated RIS controller is not established, the method further includes establishing 1640, by the associated RIS controller, communication with the particular base station and determining, by the associated RIS controller, the RIS information to be send to a central network entity.

In some embodiments, the method further includes performing 1650, by the one or more base stations, a channel sensing process, the channel sensing process including one or more of sensing communication links between the one or more base stations and the set of RISs requiring C&C and sensing cascade channels between the one or more base stations, the set of RISs requiring C&C and a terminal device.

According to some embodiments, the one or more characteristics of each base station including one or more of: proximity to the one or more RISs of the RIS deployment, channel quality of the base station, RIS usage, services to be provided using the one or more RISs of the RIS deployment, computational power of the base station and expected network traffic in an area covered by the base station.

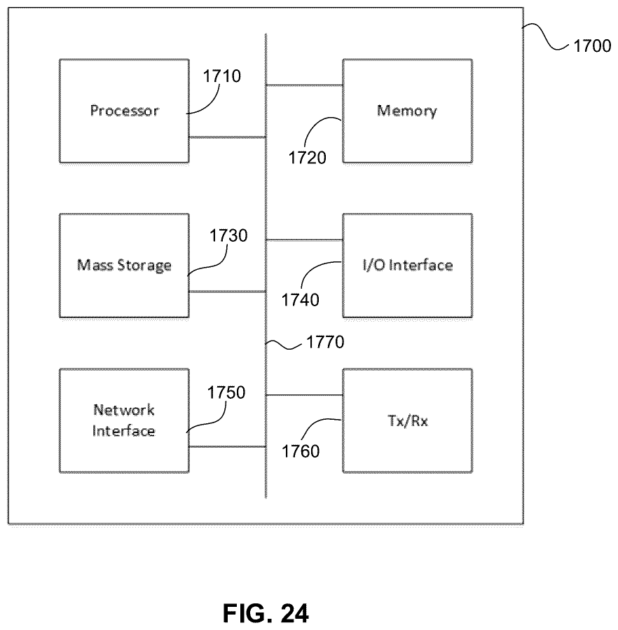

FIG. 24 is a schematic diagram of an electronic device 1700 that may perform any or all of the steps of the above methods and features described herein, according to different embodiments of the present disclosure. For example, an RIS, an RIS controller, a service management function, a network management function, an access point, a base station or other transceiver that serves as the hub of the local wireless network may be configured as the electronic device.

As shown, the device includes a processor 1710, memory 1720, non-transitory mass storage 1730, I/O interface 1740, network interface 1750, and a transceiver 1760, all of which are communicatively coupled via bi-directional bus 1770. According to certain embodiments, any or all of the depicted elements may be utilized, or only a subset of the elements. Further, the device 1700 may contain multiple instances of certain elements, such as multiple processors, memories, or transceivers. Also, elements of the hardware device may be directly coupled to other elements without the bi-directional bus.

The memory 1720 may include any type of non-transitory memory such as static random access memory (SRAM), dynamic random access memory (DRAM), synchronous DRAM (SDRAM), read-only memory (ROM), any combination of such, or the like. The mass storage element 1730 may include any type of non-transitory storage device, such as a solid state drive, hard disk drive, a magnetic disk drive, an optical disk drive, USB drive, or any computer program product configured to store data and machine executable program code. According to certain embodiments, the memory 1720 or mass storage 1730 may have recorded thereon statements and instructions executable by the processor 1710 for performing any of the aforementioned method steps described above.

Although the present disclosure has been described with regards to RIS, it is evident that various features and embodiments disclosed herein can be applied to various software meta-surfaces in general. Software meta-surfaces may be more complicated than RIS deployment in that they may include more sophisticated inter-tile networking, several local controllers, and an application programming interface (API) at the configuration server to hide inner complexities and provide an abstraction layer. Alternatively, the RIS services may be provided by an RIS provider or manager, which can also provide an abstraction layer.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the disclosure are examples and can be varied in many ways. Such present or future variations are not to be regarded as a departure from the spirit and scope of the disclosure, and all such modifications as would be obvious to one skilled in the art are intended to be included within the scope of the following claims.

1. A method for configuring one or more reconfigurable intelligent surface (RIS) deployments, each RIS deployment including one or more RISs to support network services, comprising:
sending a request for RIS information;
receiving the RIS information, the received RIS information including information indicative of one or more of: a capability of one or more base stations for provision of control and communication (C&C) of the one or more RIS deployments, one or more configurable RISs and one or more characteristics of each base station; and
determining a RIS C&C set based on one or more of: (a) one or more characteristics of each base station, and (b) the one or more characteristics of one or more of the one or more RIS deployments and an associated RIS controller included in the RIS information, the RIS C&C set including one or more base stations responsible for C&C of the one or more RIS deployments.

2. The method according to claim 1, wherein the one or more characteristics of each base station including one or more of: proximity to the one or more RISs of the RIS deployment, channel quality of a base station-RIS link, RIS usage, services to be provided using the one or more RISs of the RIS deployment, computational power of the base station and expected network traffic in an area covered by the base station.

3. The method of claim 1, further comprising:
when a particular RIS controller has not established a communication link with a base station, establishing, by the particular RIS controller, communication with the base station;
wherein establishing communication includes searching, by the particular RIS controller, radio signals broadcast by a plurality of base stations, determining, by the particular RIS controller, which base station to establish a connection according to broadcast information associated with the broadcasted radio signals, and sending a connection request to the base station.

4. The method of claim 3, wherein the broadcast information includes C&C capability of the base station.

5. The method of claim 3, wherein the broadcast information includes one or more RIS_IDs, the one or more RIS IDs indicating the one or more RIS deployments to be used by the base station.

6. The method of claim 1, further comprising:
when a particular RIS controller has not established a communication link with a base station, establishing, by the particular RIS controller, communication with the base station;
wherein establishing communication includes broadcasting a pilot signal by the particular RIS controller, and upon detection of the pilot signal by the base station, establishing a communication link with the particular RIS controller.

7. The method of claim 1, further comprising:
performing, by the one or more base stations, a channel sensing process, the channel sensing process including one or more of:
sensing communication links between the one or more base stations and the set of RISs requiring C&C, and
sensing cascade channels between the one or more base stations, the set of RISs requiring C&C and a terminal device.

8. An apparatus for configuring one or more reconfigurable intelligent surface (RIS) deployments, each RIS deployment including one or more RISs to support network services, the apparatus comprising:
a processor; and
a memory storing machine executable instructions, which when executed by the processor configure the apparatus to:
send a request for RIS information;
receive the RIS information, the received RIS information including information indicative of one or more of: a capability of one or more base stations for provision of control and communication (C&C) of the one or more RIS deployments, one or more configurable RISs and one or more characteristics of each base station; and
determine a RIS C&C set based on one or more of: (a) one or more characteristics of each base station, and (b) the one or more characteristics of one or more of the one or more RIS deployments and an associated RIS controller included in the RIS information, the RIS C&C set including one or more base stations responsible for C&C of the one or more RIS deployments.

9. The apparatus according to claim 8, wherein the one or more characteristics of each base station including one or more of: proximity to the one or more RISs of the RIS deployment, channel quality of a base station-RIS link, RIS usage, services to be provided using the one or more RISs of the RIS deployment, computational power of the base station and expected network traffic in an area covered by the base station.

10. The apparatus of claim 8, comprising:
when communication between a base station and a particular RIS controller is not established, the instructions when executed by the processor further configure the apparatus to:
establish communication with the base station;
wherein establishing communication includes searching radio signals broadcast by a plurality of base stations, determining which base station to establish a connection according to broadcast information associated with the broadcasted radio signals, and sending a connection request to the base station.

11. The apparatus of claim 8, wherein the broadcast information includes C&C capability of the base station.

12. The apparatus of claim 8, wherein the broadcast information includes one or more RIS_IDs, the one or more RIS IDs indicating the one or more RIS deployments to be used by the base station.

13. The apparatus of claim 8, wherein the instructions when executed by the processor further configure the apparatus to:
when a particular RIS controller has not established a communication link with a base station, establish communication with the base station;
wherein establishing communication includes broadcasting a pilot signal and upon detection of the pilot signal by the base station, establishing a communication link with the particular RIS controller.

14. The apparatus of claim 8, wherein the instructions when executed by the processor further configure the apparatus to:
perform a channel sensing process, the channel sensing process including one or more of:
sensing communication links between the one or more base stations and the set of RISs requiring C&C, and
sensing cascade channels between the one or more base stations, the set of RISs requiring C&C and a terminal device.

15. A system for configuring one or more reconfigurable intelligent surface (RIS) deployments, each RIS deployment including one or more RISs to support network services, the system including a RIS controller, one or more base stations and a central manager (CM), wherein
the CM is configured to:
send a request for RIS information to each of the one or more base stations;
each base station is configured to:
receive the RIS information from the RIS controller associated with the one or more RIS deployments; and
send second RIS information to the CM, the second RIS information including information indicative of a capability of the base station for provision of control and communication (C&C) of the one or more RIS deployments, one or more configurable RISs and one or more characteristics of the base station; and
the CM is further configured to:
determine a RIS C&C set based on one or more of: (a) one or more characteristics of the one or more base stations, and (b) the one or more characteristics at least in part determined from the second RIS information, the RIS C&C set including one or more base stations responsible for C&C of the one or more RIS deployments.

16. The system according to claim 15, wherein the one or more characteristics of each base station including one or more of: proximity to the one or more RISs of the RIS deployment, channel quality of a base station-RIS link, RIS usage, services to be provided using the one or more RISs of the RIS deployment, computational power of the base station and expected network traffic in an area covered by the base station.

17. The system of claim 15, wherein when a particular RIS controller has not established a communication link with a base station, wherein the particular RIS controller is configured to:
establish communication with the base station;
wherein establishing communication includes searching, by the particular RIS controller, radio signals broadcast by a plurality of base stations, determining, by the RIS controller, which base station to establish a connection according to broadcast information associated with the broadcasted radio signals, and sending a connection request to the base station.

18. The system of claim 16, wherein the broadcast information includes C&C capability of the base station.

19. The system of claim 16, wherein the broadcast information includes one or more RIS_IDs, the one or more RIS IDs indicating the one or more RIS deployments to be used by the base station.

20. The system of claim 15, wherein when a particular RIS controller has not established a communication link with a base station, wherein the RIS controller is configured to:
establish communication with the base station;
wherein establishing communication includes broadcasting a pilot signal by the particular RIS controller, and upon detection of the pilot signal by the base station, establishing a communication link with the particular RIS controller.

21. The system of claim 15, wherein the base station is configured to:
perform a channel sensing process, the channel sensing process including one or more of:
sensing communication links between the base station and the set of RISs requiring C&C, and
sensing cascade channels of the base station, the set of RISs requiring C&C and a terminal device.
